(19) United States
(12) Patent Application Publication
(10) Pub. No.: US 2025/0290708 A1
(43) Pub. Date: Sep. 18, 2025

(54) THERMAL ENERGY STORAGE APPARATUS

(71) Applicant: Graphite Solar Power Pty. Limited, Surry Hills (AU)

(72) Inventors: Jun CHAO, North Ryde (AU); Paul Soo-Hock KHOO, Castle Hill (AU)

(73) Assignee: Graphite Solar Power Pty. Limited, Surry Hills (AU)

(21) Appl. No.: 19/221,969

(22) Filed: May 29, 2025

Related U.S. Application Data
(62) Division of application No. 17/420,358, filed on Jul. 1, 2021.

(30) Foreign Application Priority Data
Jan. 9, 2019 (AU) 2019900074

(51) Int. Cl. F28D 20/00; F28F 21/02

(52) U.S. Cl. CPC F28D 20/0056; F28F 21/02; F28D 2020/0013; F28D 2020/0078

(57) ABSTRACT

The present invention provides a thermal energy storage apparatus comprising a housing which defines a hollow interior chamber, the chamber arranged in use to house graphite solids material in an inert gas atmosphere therewithin; and at least one conduit arranged to extend through the hollow interior chamber via inlet and outlet openings in the housing, the conduit being sealingly fitted to the housing at the inlet and outlet openings, and an exterior surface of the or each conduit being arranged in a close facing relationship with the graphite solids material located within the hollow interior chamber, wherein, in use, the or each conduit is arranged for conveying a flow of a fluid therethough such that in a first configuration, said flow transfers thermal energy to the graphite solid material, and in a second configuration, the graphite solid material transfers thermal energy to said flow.

### FIELD OF THE INVENTION

This disclosure relates generally to to the field of energy storage and in particular to apparatus for storage and use of energy which is generated by renewable sources such as photovoltaics, wind and wave power. However, the concepts disclosed may be used with any source of energy which generates power in excess of the immediate demand at certain periods of the day, and which requires a temporary energy storage solution for time-shifting purposes.

The disclosure is concerned with a thermal heat storage apparatus and method, but it will be appreciated that many other areas are applicable. For example, users may be able to capture excess heat generated by conventional fossil fuel burning or electric power generation, as well as from diverse areas such as factory waste heat recovery, and geothermal power generation.

### BACKGROUND OF THE INVENTION

Any discussion of the prior art throughout the specification should in no way be considered as an admission that such prior art is widely known or forms part of common general knowledge in the field.

Worldwide there is an increasing awareness of the need to reduce reliance on fossil fuels and increase the use of renewable energy sources. One major renewable energy source that is effectively unlimited in the foreseeable future is solar energy (and other types of photovoltaic (PV) energy capture), however solar energy has the disadvantage that it is not available at night, nor during bad weather or even during cloudy periods, and so conversion systems for renewable energy equipment need to include some form of energy storage if they are to improve dispatchability to become a viable replacement for fossil fuel as a source of energy.

Other renewable energy sources such as wind, wave and tidal power also have variable output at best and in some cases are unpredictably variable. In order to ensure availability of capacity to meet demand, some means of storage is required to match that supply with the demand if it occurs at times outside of peak renewable energy capture hours. Current batteries are expensive and limited to short term grid frequency stabilisation roles rather than for load shifting to cater for the secondary peak demands when the sun is not shining.

What is known now is that this general field of so-called “thermal energy storage” (TES) can be achieved with widely differing technologies. Depending on the specific technology, excess thermal energy can be stored and used hours, days, or months later, at scales ranging from individual process, building, multiuser-building, district, town, or region. One method which has been proposed for energy storage, is to heat a body when energy production exceeds demand, and to recover the heat and convert it to electricity when demand exceeds supply. Various materials have been proposed for use in heat storage bodies, and it has been found that graphite is particularly useful in this role. However, it is well known that graphite is combustible at certain conditions at very high temperature, so this presents special challenges if it is to be used as a heat storage medium.

Carbon in the form of graphite is used in a variety of applications to store heat or buffer heat generation in high temperature plant. A continual risk in such applications is the possibility of a graphite fire if the graphite at high temperature comes into contact with oxygen (or air).

It is an object of the present invention to overcome or ameliorate at least one of the disadvantages of the prior art, or to provide a useful and/or safer alternative. There is a general desire in the art for an energy storage system which can overcome at least some of the identified limitations by offering a cost effective, safe and efficient way to store and distribute excess energy.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

In a first aspect, embodiments are disclosed of a thermal energy storage apparatus comprising: a housing which defines a hollow interior chamber, the chamber arranged in use to house graphite solids material in an inert gas atmosphere therewithin; and at least one conduit arranged to extend through the hollow interior chamber via inlet and outlet openings in the housing, the conduit being sealingly fitted to the housing at the inlet and outlet openings, and an exterior surface of the or each conduit being arranged in a close facing relationship with the graphite solids material located within the hollow interior chamber, wherein, in use, the or each conduit is arranged for conveying a flow of a fluid therethough such that in a first configuration, said flow transfers thermal energy to the graphite solid material, and in a second configuration, the graphite solid material transfers thermal energy to said flow.

In some embodiments, the fluid is a thermal (heat) energy transfer fluid which operates such that: in the first configuration, the flow of fluid conductively heats the or each conduit, and the conduit conducts and radiates heat towards the graphite solid material, and in the second configuration, the graphite solid material conducts and radiates heat towards the or each conduit, and the conduit conductively heats the flow of fluid therewithin,

In some embodiments, the graphite solid material is repeatedly heated and cooled by the respective transfer of thermal energy, into and from, the flow of said thermal energy transfer fluid.

In some embodiments, when the apparatus is arranged with a single conduit, then to operate with both the first and the second configuration, the conduit is adapted to convey different fluids sequentially therethrough.

In some embodiments, said conduit comprises a material suitable for conveying a flow of a high temperature fluid (HTF) or a supercritical fluid when in the first configuration, and said conduit comprises a material suitable for conveying a flow of a supercritical fluid when in the second configuration. In alternative embodiments, said conduit comprises a material suitable for conveying a flow of a high temperature fluid (HTF) or a supercritical fluid when in the first configuration, and said conduit comprises a material suitable for conveying a flow of a high temperature fluid (HTF) when in the second configuration.

In some embodiments, when the apparatus is arranged with at least two conduits, then to operate with the first configuration, the apparatus is adapted to convey fluid in a first conduit, and to operate with the second configuration, the apparatus is adapted to convey fluid in a second, separate conduit.

In some embodiments, said first conduit comprises a material suitable for conveying a flow of a high temperature fluid (HTF) or a supercritical fluid, and said second conduit comprises a material suitable for conveying a flow of a supercritical fluid. In alternative embodiments, said first conduit comprises a material suitable for conveying a flow of a high temperature fluid (HTF) or a supercritical fluid, and said second conduit comprises a material suitable for conveying a flow of a high temperature fluid.

In some embodiments, the high temperature fluid (HTF) is at least one of the group comprising: liquid sodium (Na); liquid potassium (K), liquid NaK (77.8% K), liquid tin (Sn), liquid lead (Pb), liquid lead-bismuth (PbBi) (45%/55%).

In some embodiments, the supercritical fluid is at least one of the group comprising: carbon dioxide (CO₂), methane (CH₄), ethane (C₂H₆), propane (C₃H₈), ethylene (C₂H₄), propylene (C₃H₆), methanol (CH₃OH), ethanol (C₂H₅OH), acetone (C₃H₆O), and nitrous oxide (N₂O). In some embodiments, the first and second conduit comprises a material with an operating temperature range of about 550° C. to about 1000° C. In one particular form of this, the first and second conduit comprises a material with an operating temperature range of about 550° C. to about 900° C., 700° C. to about 900° C. or 550° C. to about 800° C. In other embodiments, the operating temperature range may be about 600-1000° C., about 700-1000° C., about 800-1000° C., about 900-1000° C., about 550-900° C., about 550-800° C., about 550-700° C., about 550-600° C., about 600-900° C., about 600-800° C., or about 600-700° C.

In some embodiments, the inert gas atmosphere within the hollow interior chamber is maintained by means of a substantially gas-tight housing which encases the graphite solids material, and an initial introduced quantity of inert gas. In some alternative embodiments, the inert gas atmosphere within the chamber is maintained by means of a positive flow of inert gas being fed into the housing which encases the graphite solids material. For example, inert gas such as argon can be periodically pumped into the uppermost end of the hollow chamber via a gas entry port, located above the graphite blocks and powder contents, to displace any oxygen which may find its way in. In some embodiments, the graphite solids material can produce inert gas during operation without relying on an external system. For example, heating up the graphite solids material to operating temperatures such as about 550° C. to 1000° C. in air can produce carbon monoxide and carbon dioxide which are inert gases.

In some embodiments, the graphite solids material in the hollow interior chamber comprises a plurality of solid blocks of graphite adapted for embedding the or each conduit, as well as powdered graphite placed therearound, to substantially fill remaining void spaces in said chamber.

In some embodiments, the hollow chamber is shaped as a rectangular prism and appears as a panel with top, side edge lifting and mounting adaptations. The thermal energy storage panels may each contain no more than 5000 kg of graphite and each may contain between 2000 kg and 3800 kg or between 2000 kg and 3000 kg of graphite.

In some embodiments, the conduit for conveying a flow of a high temperature fluid (HTF) or a supercritical fluid in said first configuration, provides fluid communication to an upstream source for heating for said fluid.

In some embodiments, the conduit for conveying a flow of a supercritical fluid in said second configuration provides fluid communication to a downstream supercritical fluid turbine.

In a second aspect, embodiments are disclosed of a thermal energy storage module comprising: a plurality of the thermal energy storage apparatus disclosed in the first aspect; the housing of each of said apparatus being adapted to be mounted and suspended from a frame which is locatable inside of an intermodal shipping container; and the inlet and outlet openings of the or each conduit which are provided at the housing being externally connected to an input and an output manifold, which in use are for conveying a flow of the fluid through the conduit(s).

In some embodiments, the thermal energy storage module may comprise between 2 and 40 thermal energy storage panels and preferably between 4 and 16 thermal energy storage panels.

The thermal energy storage module inlet manifold can connect the conduit inlets of the plurality of thermal energy storage panels. An inlet manifold temperature sensor may measure inlet manifold temperature. The thermal energy storage module can also include an outlet manifold which connects the conduit outlets of the plurality of thermal energy storage panels. An outlet manifold temperature sensor may measure outlet manifold temperature.

In some embodiments of the module, each of the plurality of thermal energy storage apparatus has one or more relevant sensors to measure a condition of the graphite solids material therewithin.

In some embodiments of the module, the conditions measured include one or more of the group comprising: temperature of the graphite solids material, the amount of inert gas pressure, and the amount of oxygen present.

Each thermal energy storage apparatus (shown in the Figures in the form of a panel) may have an oxygen or an inert gas sensor for monitoring the level of an inert gas (such as argon) which is used to fill voids in the thermal energy storage panel and/or detecting oxygen within the thermal energy storage panel.

Methods of testing the condition of the inert gas may include: i) when temperature is stable, by conducting a pressure hold test; ii) using an oxygen sensor to detect presence of oxygen within the panel; iii) measuring flow of inert gas into the panel to detect abnormal inflow rates.

Sensors for measuring a condition of an inert gas such as argon in the thermal energy storage panels may also be connected to the PLC and the PLC may be programmed to monitor the sensors and to control the valves, pumps or other ancillary devices, and perhaps to isolate the flow of supercritical fluid, or to cut the supply of power to a particular thermal energy storage panel if the condition of the inert gas in it deteriorates below a predetermined level, such as by pressure dropping below a predetermined level or pressure or decreasing rapidly.

Alternatively, a flow meter may be used on an inert gas inlet line to monitor gas consumption and operate the electronic power control devices if gas supply suddenly increases indicating a possible breach of the exterior wall or skin of the chamber of the thermal energy storage panel. Detection of the presence of oxygen within a thermal energy storage panel may also be used to operate the electronic power control devices.

In some embodiments of the module, a programmable logic controller (PLC) is provided, such that signals from relevant sensors for monitoring the graphite solids material are connected to the PLC, and related responsive electronic control devices are controlled by the PLC, wherein the PLC is programmed to monitor the relevant sensors and to control the fluid flow to the module.

The PLC may be programmed to provide signal outputs and inputs for transmission to and from system level controllers such as a Distributed Control System (DCS) and displays providing control functions and indicating measured and calculated parameters including one or more of: Module Average Graphite Temperature; Module Max Graphite Temperature (indicating which temperature sensor on which Panel); Module Min Graphite Temperature (indicating which temperature sensor on which Panel); Module State of Charge percentage; Module State of Thermal Charge kWht; Inert Gas (e.g., argon) Pressure and or Flow rate; Inlet manifold and outlet manifold temperature; System generated commands to start or stop heating.

A local display may be provided to display the outputs from the PLC. The PLC may measure inlet manifold temperature and transmit the inlet manifold temperature to a central controller. The PLC may also measure outlet manifold temperature and transmit the outlet manifold temperature to a central controller.

In a third aspect, embodiments are disclosed of a method of operating a closed-loop power generation system with a supercritical fluid as the working fluid, the power generation system comprising a thermal energy storage apparatus, and a supercritical fluid turbine, and the method comprising the steps of: storing energy using a high temperature thermal energy storage apparatus comprising graphite solids material; and then, at a time when the energy is needed: using the stored thermal energy to heat the components of a flow of a supercritical fluid by placing these components into contact with the thermal energy storage apparatus via a conduit; and placing a flow of the resulting supercritical fluid into fluid communication with a downstream supercritical fluid turbine.

In some embodiments of the method, after the flow of the supercritical fluid passes through the downstream supercritical fluid turbine, it is returned to the conduit for further heating.

In some embodiments of the method, the supercritical fluid is used to operate the turbine to generate electricity.

In some embodiments of the method the thermal energy is stored in graphite solid material which is housed in a chamber in an inert gas atmosphere.

In a fourth aspect, embodiments are disclosed of a method of operating a thermal energy storage apparatus, the method comprising the steps of: making a fluid connection to a housing, the housing comprising a hollow interior chamber substantially filled with graphite solids material in an inert gas atmosphere, the housing having at least one conduit arranged to extend through the hollow interior chamber via inlet and outlet openings in the housing, the conduit being sealingly fitted to the housing at the inlet and outlet openings, an exterior surface of the or each conduit being arranged in a close facing relationship with the graphite solids material located within the hollow interior chamber; conveying a flow of a high temperature fluid (HTF) or a supercritical fluid from an upstream source via the fluid connection into the or each conduit, thereby transferring thermal energy to the graphite solid material until a desired graphite temperature is reached; then, at a future time, when the thermal energy is needed downstream, the method comprises the further steps of:

making a fluid connection to the housing; using the stored thermal energy to heat the components of a flow of a supercritical fluid by placing these components into contact with the thermal energy storage apparatus in the or each conduit; and placing a flow of the resulting supercritical fluid into fluid communication with a downstream supercritical fluid turbine.

Aspects, features, and advantages of this disclosure will become apparent from the following detailed description when taken in conjunction with the accompanying drawings, which are a part of this disclosure and which illustrate, by way of example, principles of any inventions disclosed.

### BRIEF DESCRIPTION OF THE DRAWINGS

A preferred embodiment of the invention will now be described, by way of example only, with reference to the accompanying drawings in which:

FIG. 1 is a side, top, perspective view of thermal energy storage module, in accordance with an embodiment of the present disclosure. The Figure shows a plurality of thermal energy storage apparatus, each mounted from a frame which is able to be located in a shipping container. Each storage apparatus of the module is arranged for converting energy from high temperature fluid (HTF) or from a supercritical fluid to thermal energy and storing the thermal energy in graphite for later use. In between each panel is a high temp insulation material layer, which also lags the container roof and the internal walls (but is not shown for clarity);

FIG. 2 is a side, top, perspective view of one thermal energy storage apparatus as shown in FIG. 1, when free-standing. Each storage apparatus is arranged for converting energy from high temperature fluid (HTF) or from a supercritical fluid, to thermal energy and storing the thermal energy in graphite for later use;

FIG. 3a shows a top plan view of the thermal energy storage apparatus of FIG. 2;

FIG. 3b shows a side elevation, schematic view of the apparatus of FIG. 2;

FIG. 3c shows an end elevation schematic view of the apparatus of FIG. 2;

FIG. 4 shows a perspective view of a conduit in the form of a heat exchanger coil as used internally within the apparatus of FIGS. 2, 3 and 6.

FIG. 5 shows a partial perspective view of the conduit in the form of the heat exchanger coil of FIG. 4 seated on a base capping graphite plank and showing insertion of a graphite plank adjacent to the base capping plank;

FIG. 6 shows a partial perspective view of the conduit in the form of the heat exchanger coil as shown in FIG. 4 and FIG. 5, with a number of the graphite planks inserted;

FIG. 7 shows a perspective view of the conduit in the form of the heat exchanger coil of FIG. 4, FIG. 5 and FIG. 6 when fully embedded in graphite planks, with a graphite plank partially inserted the underside;

FIG. 8 is a side, top, perspective view of one thermal energy storage apparatus as shown in FIG. 2, when free-standing. Each storage apparatus is fitted with a gas-tight exterior barrier to contain the inert gas atmosphere around the graphite;

FIG. 9 shows a cross-section of two of the planks seen in FIGS. 5, 6, 7 and 8, illustrating a half obround groove in which the conduit in the form of the heat exchanger tubing is contained;

FIG. 10 is a side, top, perspective view of thermal energy storage module, in accordance with another embodiment of the present disclosure, when free-standing. Each storage apparatus is fitted with a gas-tight exterior barrier to contain the inert gas atmosphere around the graphite. This apparatus features curved edges of the top plate, at the interface with the vertical side walls, as well as cover shape at conduit exit interfaces, to reduce zones of high stress.

FIG. 11 shows the temperature and pressure phase diagram for supercritical carbon dioxide, showing that it behaves as a supercritical fluid above its critical temperature (304.25 K, 31.1° C.) and critical pressure (72.9 atm, 7.39 MPa, 73.9 bar); and

FIG. 12 shows experimental results produced using the apparatus of FIG. 2, the data illustrating energy storage (kWh/t) of graphite as a function of the graphite temperature, in the range 100-1000° C. The experimental data (B) is shown in comparison to available Standard data (A) and demonstrates the relative efficiency of the inventive arrangement.

FIG. 13 shows the built prototype of the thermal energy storage apparatus in Example 2.

FIG. 14 shows the (a) actuator behaviour graph and (b) temperature response graph of Strategy 1.

FIG. 15 shows the (a) actuator behaviour graph and (b) temperature response graph of Strategy 2.

FIG. 16 shows (a) how the Weidmuller controller typically controls the thermal energy storage apparatus according to the instructions sent from the Matlab code and (b) shows a flow chart of the operating process.

FIG. 17 shows a typical temperature behaviour (temperature response graph) during different phases of the software during operation of the thermal energy storage apparatus.

FIG. 18 shows variations (a)-(i) of process and instrumentation diagrams developed for the prototype of Example 2.

FIG. 19 shows (a) a 3D model and thermo-hydraulic model developed using Autodesk® Inventor and Thermal Desktop for Example 3 and (b) a prototype for testing in a liquid sodium process loop.

FIG. 20 shows the sensitivity assessment of (a) average graphite temperature and (b) sodium outlet temperature during charging of the thermal energy storage apparatus of Example 3.

FIG. 21 shows (a) average graphite temperature and (b) sodium outlet temperature during charging of the thermal energy storage apparatus of Example 3.

FIG. 22 shows (a) average graphite temperature and (b) sodium outlet temperature during discharging of the thermal energy storage apparatus of Example 3.

FIG. 23 shows (a) average graphite temperature and (b) sodium outlet temperature during charging of the thermal energy storage apparatus of Example 3.

FIG. 24 shows (a) average graphite temperature and (b) sodium outlet temperature during discharging of the thermal energy storage apparatus of Example 3.

FIG. 25 shows the accumulated energy transfer of (a) charging with an average graphite temperature of 500° C. and sodium inlet temperature of 800° C.; and (b) discharging with an average graphite temperature of 800° C. and sodium inlet temperature of 500° C. for the thermal energy storage apparatus of Example 3.

FIG. 26 shows the accumulated energy transfer of (a) charging with an average graphite temperature of 300° C. and sodium inlet temperature of 500° C.; and (b) discharging with an average graphite temperature of 500° C. and sodium inlet temperature of 300° C. for the thermal energy storage apparatus of Example 3.

FIG. 27 shows the energy transfer rate of (a) charging with an average graphite temperature of 300° C. and sodium inlet temperature of 500° C.; and (b) charging with an average graphite temperature of 500° C. and sodium inlet temperature of 800° C. for the thermal energy storage apparatus of Example 3.

### DETAILED DESCRIPTION OF A PREFERRED EMBODIMENT

This disclosure relates generally to to the field of energy storage, and in particular to an apparatus and method for the storage and use of thermal (or heat) energy. The inventors have devised a process which makes maximum use of carbon in the form of graphite as a high-efficiency thermal energy storage medium, which has been found to exhibit an increase in its thermal energy storage capacity as its temperature is increased.

The conversion of thermal energy to steam to drive a steam generator is very mature power generation technology, which normally requires steam with a temperature in the range 400 to 580° C. It is known that this technology is limited to a conversion efficiency of about 36%, and in addition, the physical chemistry of a steam power plant means that there long effective “start-up” time for the plant to generating power. The low conversion efficiency means that such power plants need economies of scale to make them viable, but this also means they will be capital cost intensive.

Graphite is known to be able to be heated to very high temperatures (over 1200° C.) so it is well-suited to be the basis for high temperature storage of heat or as a buffer to heat generation in high temperature plant. In experiments conducted by the inventors, and which are attached in FIG. 12, the data show that the energy storage capacity (kWh/t) of graphite as a function of the graphite temperature, in the range 200-1000° C. goes up remarkably (by roughly a factor of 10). The inventors realised the possibility of matching the increased in energy storage capacity with temperature, by using a complementary high temperature heat transfer (“working”) fluid like supercritical CO₂ (“sCO₂”) which also operates well in the temperature range of about 550° C. to 1000° C., preferably 700° C. to 900° C.

Referring specifically to FIG. 12, the data confirm the effect of a higher operating temperature range using supercritical fluids as a heat transfer fluid-noting also that the heat capacity of graphite increases with temperature. For steam power generation operating between 400° C. to 600° C., the energy stored equals 280−170=110 kWht/tonne of graphite×36% steam generator efficiency=40 kWhe/tonne (i.e., line A). However, for sCO₂ power generation operating between 700° C. to 900° C., the energy stored equals 480-350=130 kWht/tonne of graphite×45% sCO₂ efficiency=59 k Whe/tonne (i.e., line B). Accordingly, the sCO₂ power generating potential per tonne of graphite is 47% higher than for steam power generation.

Supercritical carbon dioxide (sCO₂) is a fluid state of carbon dioxide where it is held at or above its critical temperature and critical pressure. Carbon dioxide usually behaves as a gas in air at standard temperature and pressure (STP), or as a solid (dry ice) when frozen. If the temperature and pressure are both increased from STP to be at or above the critical point for carbon dioxide, it can adopt properties midway between a gas and a liquid. More specifically, it behaves as a supercritical fluid above its critical temperature (304.25 K, 31.1° C.) and critical pressure (72.9 atm, 7.39 MPa, 73.9 bar), expanding to fill its container like a gas but with a density like that of a liquid. Reference should be made to FIG. 11 in the present application.

As a working fluid, sCO₂ has desirable properties such as being chemically stable, low-cost, non-toxic, non-flammable and readily available. Such properties are therefore useful in closed-loop power generation applications, when looking for a non-flammable working fluid to use with graphite. sCO₂ power cycles (Brayton Cycle) typically operate between 500° C. and 900° C.

In the case of sCO₂, the higher the temperature the more efficient energy conversion from thermal to electricity. Some studies show that under 600° C. the conversion efficiency is same as steam cycle (Rankine Cycle) but over about 650° C. then efficiencies can reach 58% at 850° C.

An sCO₂-based turbine was recently operated at 50% efficiency. In it the sCO₂ was heated to 700° C. It required less compression and it reaches full power in 2 minutes, whereas steam turbines need at least 30 minutes. The prototype generated 10 MW and is only approximately 10% the size of a comparable steam turbine.

In effect, this means that, using sCO₂ in combination with the thermal energy storage capacity of Graphite could significantly and synergistically multiply the electrical power produced per unit of input energy required.

In addition, due to its high fluid density, sCO₂ enables extremely compact and highly efficient turbomachinery. It can use simpler, single casing body designs whereas steam turbines require multiple turbine stages and associated casings, as well as additional inlet and outlet piping. Power generation systems that use traditional air Brayton and steam Rankine cycles can be upgraded to sCO₂ to increase efficiency and power output.

Furthermore, due to its superior thermal stability and non-flammability, direct heat exchange from high temperature sources is possible, permitting higher working fluid temperatures and therefore higher cycle efficiency. And unlike two-phase flow, the single-phase nature of sCO₂ eliminates the necessity of a heat input for phase change that is required for the water to steam conversion, thereby also eliminating associated thermal shock stress, fatigue stress and corrosion.

Apart from cost effectiveness and efficiency the questions of safety is crucial because of the possibility of a graphite fire if the graphite at high temperature comes into contact with oxygen (or air). Prior systems which utilise graphite as a thermal energy storage medium, were (and are) susceptible to catastrophic failure because of their design. When electrical heating elements directly heat a large block of graphite with embedded conduit to convert the stored energy into steam, there is a high level of risk of fire. In the present disclosure, the graphite is encased in a fully welded shell and embedded with multiple conduits in the form of heat exchangers, useful for both heating up the graphite block as well as for provision of heat energy to the supercritical fluid. The use of multiple suspended panels of graphite with multiple embedded conduits connected externally to input and output manifolds readily allows the charging of heat transfer fluid and the removal of heated heat transfer fluid. The heat transfer rate and heat extraction rate can therefore be regulated by flow control valves on the manifolds.

Finally, the sealed graphite panels may be purged with argon and presence of oxygen monitored by oxygen sensors. Thermocouples are inserted in each panel allowing the temperature of each panel to be monitored and flow regulated as required, to maximise performance.

In summary, the apparatus and method of operation disclosed has the following advantages: safety—all conditions for graphite fire designed out; transportable—can be moved using intermodal frame and shipping; scalable—modules can be added as required, and the panels are designed for high volume manufacture; and efficiency—the synergy of the optimised temperature of operation for both the non-flammable working fluid sCO₂, and the increased heat storage capacity of graphite.

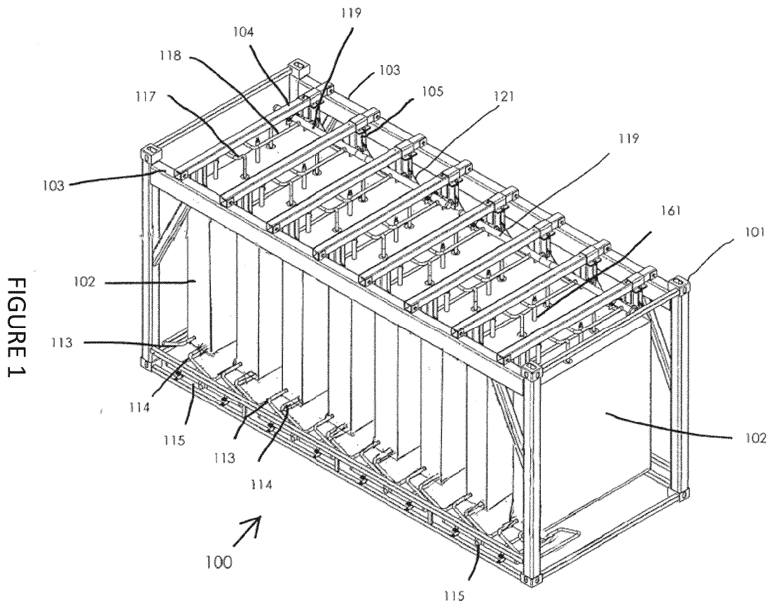

Referring to FIG. 1, an energy storage module 100 is illustrated. The thermal 20 energy storage module 100 is housed in a housing 101 having the dimensions of a standard intermodal shipping container making the unit relatively easy to transport using conventional transportation equipment. The housing 101 would typically have an outer skin and insulation within, which are not shown in FIG. 1 to permit a view of internal components. Within the housing a plurality of discrete thermal energy storage panels 102 are shown suspended. Each thermal energy storage panel 102 has a metal shell containing a graphite body and embedded conduits for heat recovery also described in detail below.

The thermal energy storage panels 102 are suspended from mounting frames 105 to which they are bolted. The mounting frames 105 are in turn suspended from cross 30 members 104 supported between upper rails 103 of the housing 101 of the thermal energy storage module 100.

Each of the thermal energy storage panels 102 includes embedded conduits, which carry a heat transfer fluid and enable heat to be recovered from the thermal energy storage panels. Inlet conduits 113, 114 deliver heat transfer fluid to each thermal energy storage panel 102 from inlet manifolds 115, and after being heated, the heat transfer fluid is passed from each thermal energy storage panel 102 via outlet conduits 117, 118 connected to outlet manifolds 119.

When the demand for electrical energy exceeds the supply, a heat transfer fluid is passed through the conduits embedded in the graphite to extract the stored heat for use. The system is quick to warm up the power generating system (e.g., sCO₂ turbine or some other supercritical fluid turbine) used for power generation.

A plurality of thermal energy storage modules 100 may be used in a system with different thermal energy storage modules being switched in to receive excess energy as the amount of excess energy increases. Similarly, different thermal energy storage modules 100 may be brought on-line to permit recovery of stored energy as demand increases above the available supply of energy.

The use of a plurality of thermal energy storage panels in the thermal energy storage module described herein, and the method of their operation, constrains the possibility of a graphite fire. When the graphite in each thermal energy storage panel is encased in a chamber which has a high temperature stainless steel skin and with the void space filled with an inert gas, such as argon gas. The condition of the inert gas may be continuously monitored, and the module unit shut down or its operating temperature reduced when the condition of the inert gas in a thermal energy storage panel is lost. For example, the pressure of the inert gas may be monitored and the module shut down if the pressure in one thermal energy storage panel drops below a predetermined level, or if while temperature is stable the pressure does not remain within predefined limits. The thermal energy storage panels may also include an oxygen sensor to monitor for presence of oxygen and the heating may be shut down if oxygen is detected in any significant amount.

Each thermal energy storage panel may have a plurality of temperature sensors such as thermocouples to measure graphite temperature at multiple locations within the panel. The graphite can be heated to a maximum operating temperature (e.g., about 550-1000° C., preferably about 700-900° C.), which is synchronous with sCO₂, and which is also well below the temperature at which a graphite fire can be initiated or sustained (i.e., >1400° C.).

The thermal energy storage module may comprise 8 thermal energy storage panels, with each one containing 2200 kg of graphite. Each thermal energy storage panel is separated from the adjacent energy storage panels in the module, and each energy storage panel is encased by a high temperature steel skin. This separates the graphite mass into small sub-units, which are each below the critical mass required for initiation or maintenance of a graphite fire.

The thermal energy storage module is designed to extract heat efficiently through the embedded conduits in the form of heat exchanger tubes in the graphite of each thermal energy storage panels. The current embodiment of the thermal energy storage module has been rated to extract 3.6 MWh of thermal energy over 4 hours but can be designed to extract more or less over a shorter or longer period of time depending on the various parameters (e.g., heat transfer fluid, flow rate, etc.) chosen to suit the particular application, without departing from the fundamental design principles discussed herein.

At the plant storage system level thermal energy storage modules may be connected in “trains” where a train consists of thermal energy storage modules connected in series and/or in parallel depending on the output conditions required for that plant.

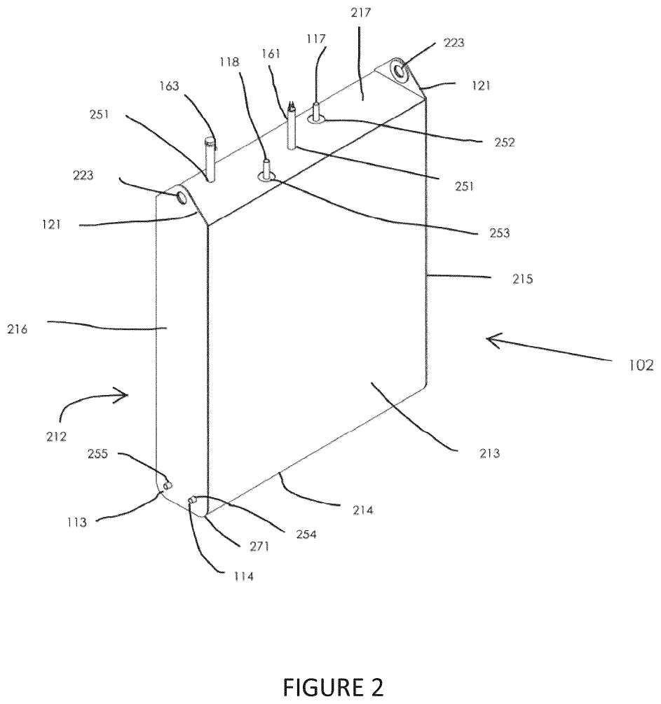

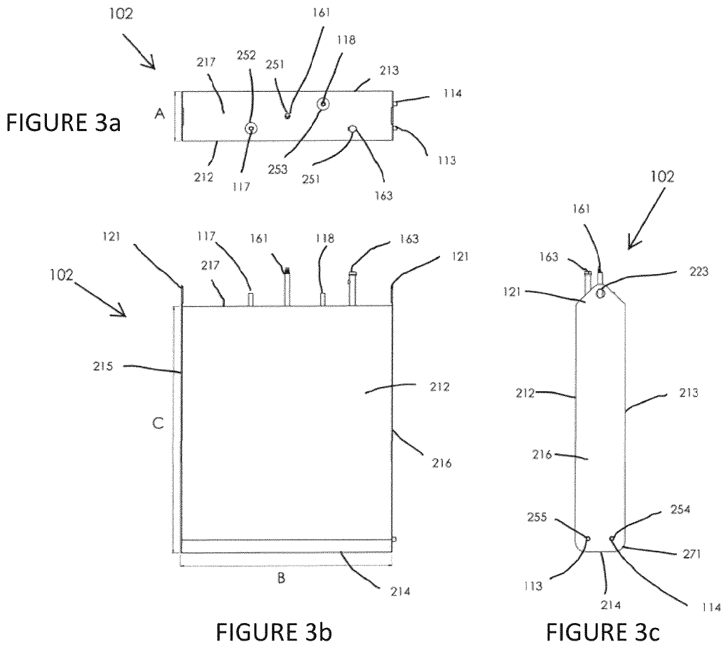

In FIG. 2 an example of the outer housing of a thermal energy storage panel 102 is illustrated in perspective view. The panel of FIG. 2 is also illustrated in FIG. 3 in plan (FIG. 3a), elevation (FIG. 3b), and end elevation (FIG. 3c) views. The thermal energy storage panel housing comprises two large substantially flat parallel side walls 212, 213 bounded by a bottom wall 214, end walls 215, 216 and a top wall 217 to form a closed container. In use the panel 102 will typically be oriented vertically with the bottom wall 214 typically located at a lower end of the panel. With reference to FIG. 2 and FIG. 3a, b, c, in one form the housing has dimensions of 2200 mm (C)×1800 mm (B)×400 mm (A) (see, FIG. 3), however these dimensions may vary to optimise usage of graphite cut from standard dimension graphite blocks and to optimise packing of complete thermal energy storage panels into containers of different sizes.

The bottom wall 214 of the housing may be integrally formed with the two side walls 212, 213 by bending a single piece of wall material into a “U” shape in which the base transitions into each of the side walls via a curved bend 271 of radius R which in the present example is in the range of 50 to 180 mm and nominally 80 mm. The wall material is preferably a sheet steel material capable of retaining structural integrity to support the enclosed graphite core, the conduit and any heat exchange fluid contained therein at elevated temperatures of at least 1000° C.

The walls of the housings in FIGS. 2 and 3 are preferably fabricated from stainless steel (316/304), or 253MA austenitic stainless steel (or any suitable high temperature thermally conductive material such as 800H austenitic steel, 800HT or alloys such as Inconel and Incoloy) finished to mill finish class 2B. The surfaces 212, 213, 214, 215, 216, 217 of the thermal energy storage panels 102 may have a natural finish to the stainless steel material (specific emissivity 0.7) or a polished surface (specific emissivity 0.2-0.3), or may be provided with another suitable surface coating or treatment (specific emissivity in the range of 0.3-0.8). The surfaces 212, 213, 214, 215, 216, 217 may also be coated with a robust high temperature heat absorbing (e.g., black-specific absorptivity in the range of 0.8-1.0, preferably 0.90-1.0) paint, surface treatment or other suitable coating.

Mounting flanges 121 are provided extending from the tops of the end walls 215, 25 216 and include respective mounting holes 223. The flanges 121 are used to suspend the panel 102 from the mounting frame 105 by bolting them to the mounting frame via the mounting holes 223. Each flange may comprise an extension of one of the end walls 215, 216 beyond the respective side wall 213 to which it is joined (i.e., the flange may be cut from the same piece of sheet material as the end walls 215, 216 from which they extend). By suspending the thermal energy storage panel from the flanges 121 rather than supporting it from below, the resulting tension in the side walls due to gravity of the graphite core acting on the housing allows them to resist buckling to maintain good thermal communication with the graphite core. The curved shape of the housing where the side walls 215, 216 join the bottom wall 214 through a bend 271 also tends to keep the metal walls pressed against the graphite core.

Vents 251 are provided in the top wall 217 of the housing to allow venting during welding together of the housing walls. These holes may be plugged (e.g., by welding after 5 the panel walls are joined), or they may be used to accommodate sealed cable ports through the wall to pass instrumentation cables such as thermocouple wires into the housing, as fill ports to provide an argon blanket to the graphite core, to accommodate a filling nozzle to fill the void space and/or an internal reservoir with graphite powder or other thermally conductive media, or to accommodate a connection to an external reservoir to maintain the 10 level of such materials when the graphite core and housing expand and contract during thermal cycling. In the illustrated embodiment, one of the vents 251 is used to accommodate sealed cable ports 161 through the wall to pass instrumentation cables such as thermocouple wires into the housing. The cable port 161 is also used as fill ports to provide the argon blanket to the graphite core. A second vent 251 is used to accommodate 15 a filling nozzle 163 to fill the void space and/or an internal reservoir with the graphite powder or other thermally conductive media.

Further holes 252, 253 are provided in the top wall 217 of the housing to allow passage of the conduit outlets 117, 118 respectively. Similarly holes 254, 255 are provided in the side wall 216 of the housing to allow passage of the conduit inlets 114, 113 respectively.

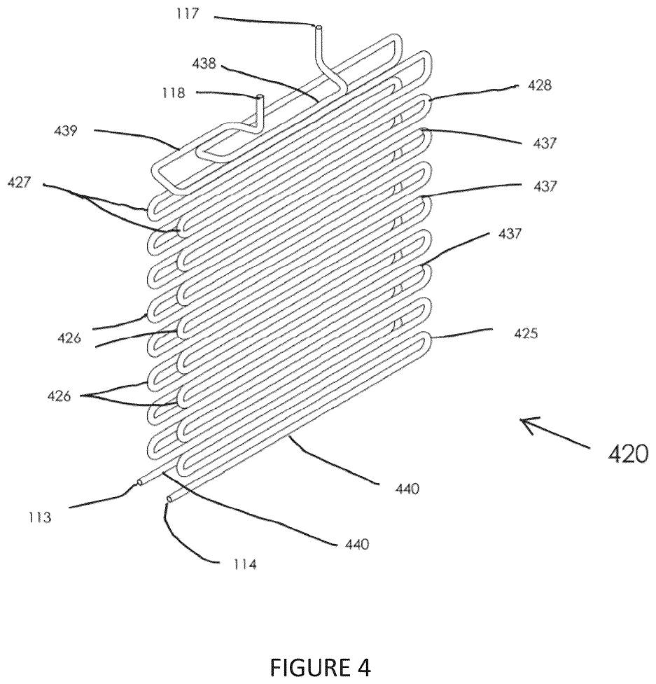

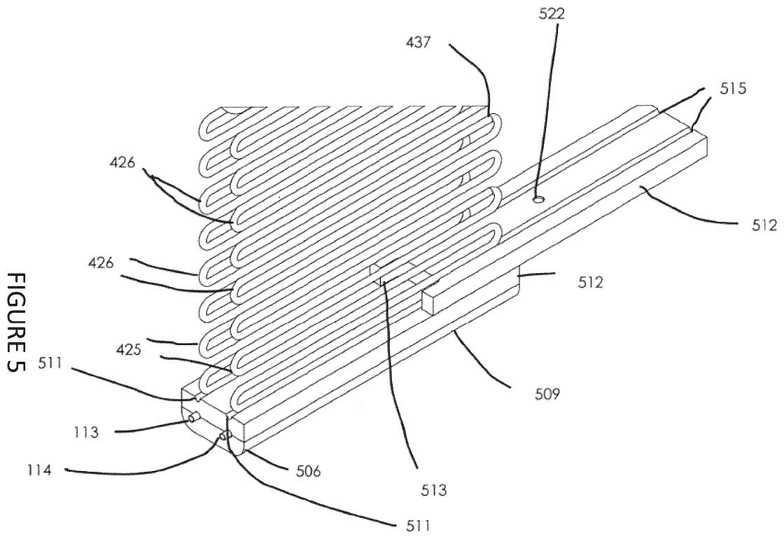

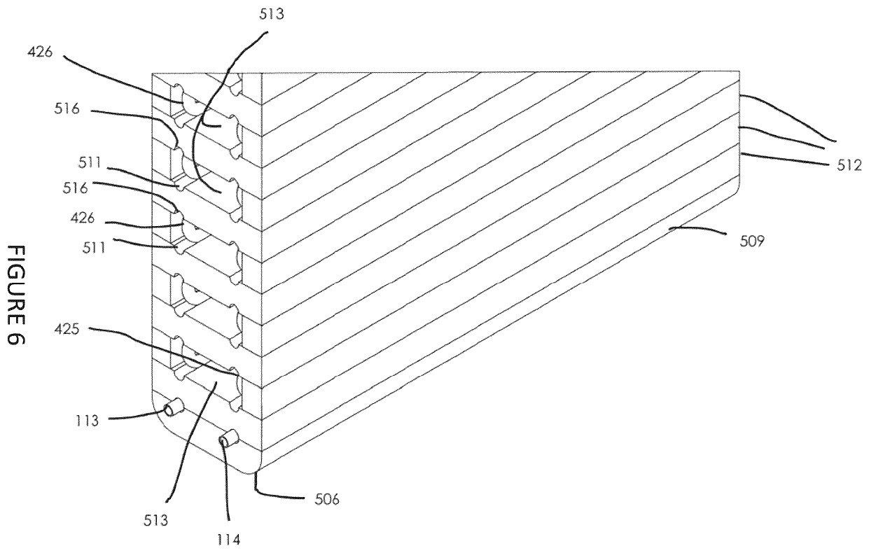

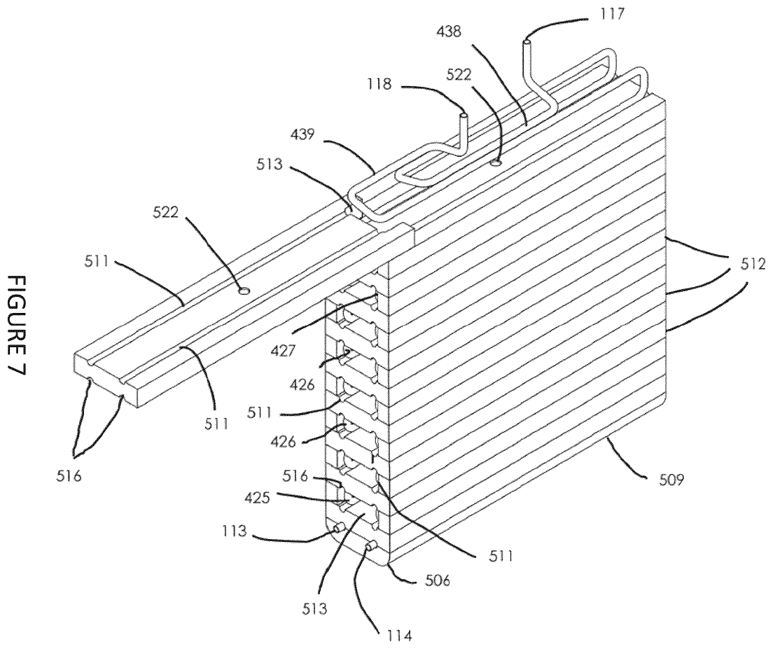

Referring to FIG. 4, a conduit 420 is shown in perspective. The conduit 420 is embedded in a graphite core as seen in FIGS. 5, 6 and 7. The conduit 420 comprises conduit 425, 426, 427, 438, 439, 440 and first and second conduit inlet 113, 114 and first and second conduit outlet 117, 118. The first and second conduit inlet 113, 114 and first and second conduit outlet 117, 118 are interchangeable as inlet or outlet depending on the direction in which it is desired to flow the heat exchange fluid through the conduit in a particular application. The conduit inlets 113, 114 terminate straight tube portions 440 which form part of a first serpentine shaped tube portion 425 comprising sequential “U” shaped sections 428. The first serpentine shaped tube portions 425, of which there are two in parallel, are joined with welded joins 437 to a plurality of intermediate serpentine shaped tube portions 426, similarly joined together by welded joins 437. Final serpentine shaped tube portions 426 are joined to final serpentine shaped tube portions 427 by further welded joins 437. The final serpentine shaped tube portions 427 each terminate in outlet sections 438, 439 which extend to the outlets 117, 118 respectively.

The number of “U” shaped sections 428 provided in the serpentine portions 425, 426, 427 can vary depending on the application. For example, for low flow rates with long discharge durations, the fewer the number of “U” shaped sections 428 may be required and conversely for high flow rates with short discharge durations more “U” shaped sections 428 may be required.

The conduits may be made, for example, from 253MA austenitic stainless steel (or any suitable high temperature thermally conductive material such as 800H austenitic steel, 800HT or alloys such as Inconel and Incoloy), and may have a nominal outside diameter in the range of for example 26.67 mm to 42.16 mm. In the present embodiment the nominal outside diameter is 33.4 mm but the outside diameter may vary to be greater or smaller than this depending on the particular circumstances of the application. The conduit 426, 439, 440, and associated conduit inlet 113, 114 and first and second conduit outlet 117, 118 are preferably formed with at least some sections of the tube assembly taking a coiled or serpentine form suitable for compression (like a spring) during assembly (e.g., the serpentine portions 425, 426, 427 and the outlet sections 438, 439), such that when the housing 102 expands due to thermal expansion, the resulting stresses from the movement of the conduit configuration does not exceed the mechanical properties of the conduit material.

Referring to FIG. 4, the conduit 420 comprises two parallel serpentine shaped tube assemblies each having independent inputs 113, 114 and outputs 117, 118, however applications may require differing numbers of coils such as 1, 2, 3, 4 coils etc. The conduit 420 is almost fully embedded in a graphite core as seen in FIGS. 5, 6, 7. The conduit 420 comprises conduit 425, 426, 427, 438, 439, 440, 117, 118, 113 and 114. The lower tube ends 113 and 114 provide the two conduit inlets and connect to the lower end of the main tube assembly comprising tube portions 425, 426, 427. The conduit inlets 113, 114 may also act as drains. The upper tube ends 117, 118 provide the two conduit outlets and terminate tube sections 439, 440 extending from the upper end of the main conduit assembly comprising conduit portions 427. The conduit portions 425, 426, 427, are joined together by welds 437. The flow may be reversed in various applications such that the inlets may be 117, 118 and the outlets may be 113, 114.

The conduits may be made, for example, from 253MA austenitic stainless steel (or any suitable high temperature thermally conductive material such as 800H austenitic steel, 800HT or alloys such as Inconel and Incoloy), and may have a nominal outside diameter of for example 33.4 mm in this embodiment but the outside diameter may vary to be greater or smaller than this depending on the particular circumstances of the application. In some embodiments, a smaller diameter conduit can be used such as a DN15 mm pipe with an outer diameter (OD) of 21.3 mm or a DN10 mm pipe with an outer diameter (OD) of 17.1 mm to cater for higher pressures.

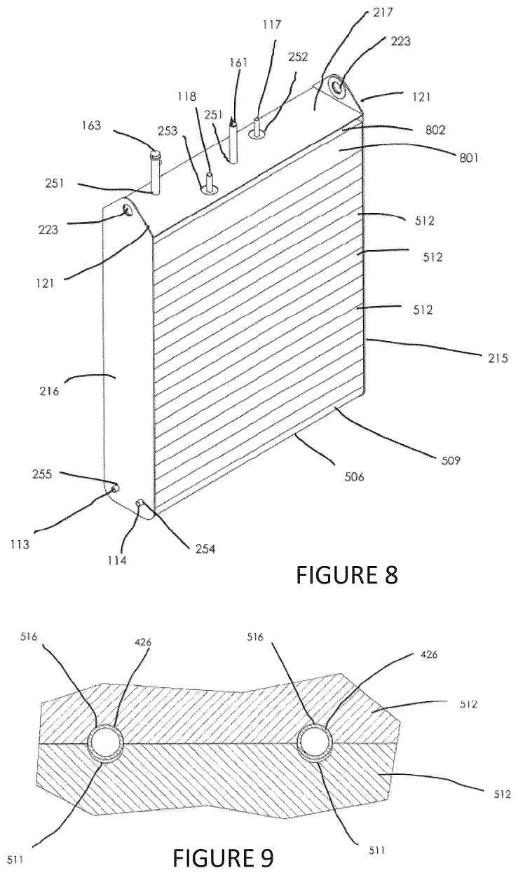

Referring to FIGS. 5, 6 and 7, the conduit inlets 113, 114 extend through the ends of grooves 511 in a bottom graphite capping plank 509. The “U” shaped bends 428 in the conduit portions 426 are accommodated in recesses 513 in the ends of the graphite planks 512. A hole 522 is also provided in the graphite planks 512 to permit the insertion of a locating tube (not shown) to maintain the location of the graphite planks after assembly. Referring to FIG. 8, the conduit outlets 117, 118 extend through openings 252, 253 in the top wall 117 of the housing 102 and the conduit inlets 113, 114 extend through openings 255, 254 in the bottom of the end wall 216 of the housing 102. The conduit portions 425, 426, 427 are able to move to accommodate expansion of the conduit in use, without exceeding the material limits of the conduit.

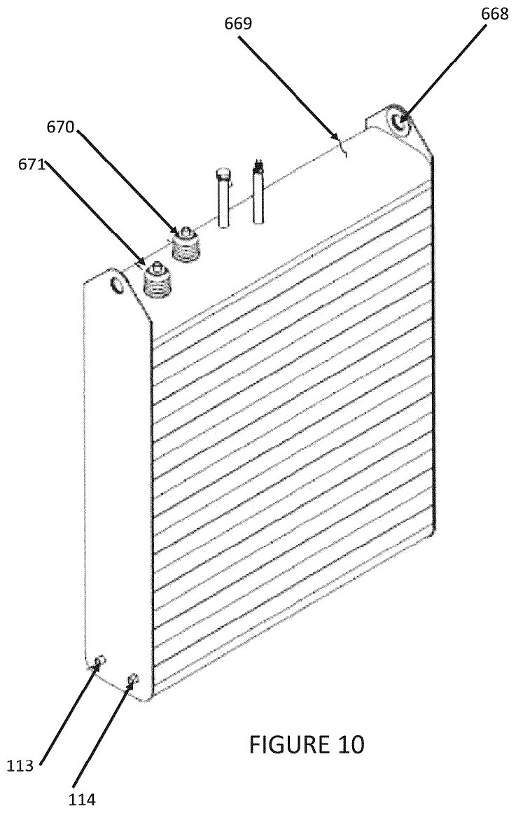

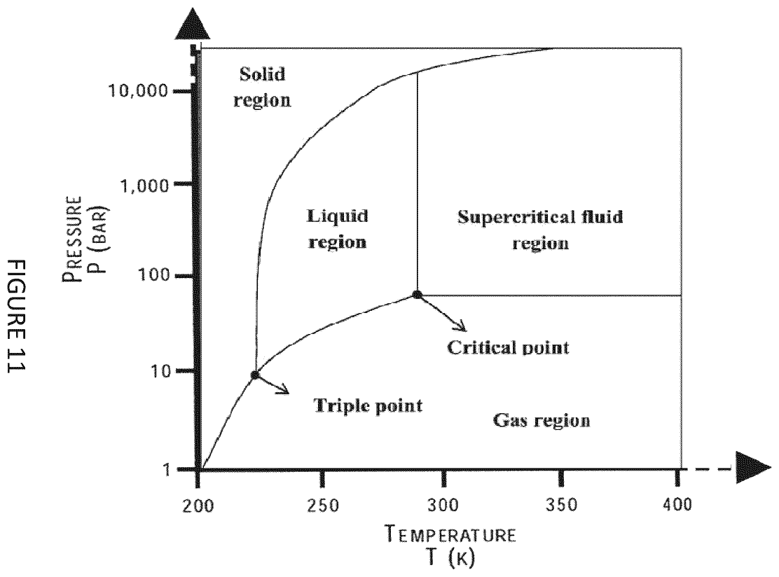

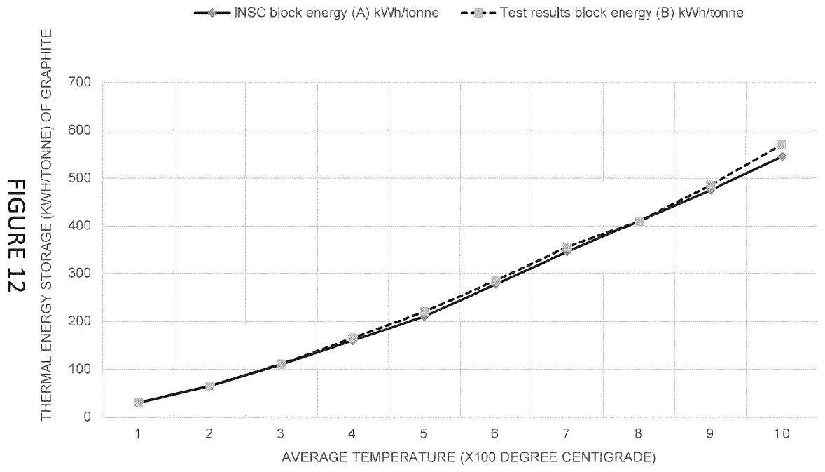

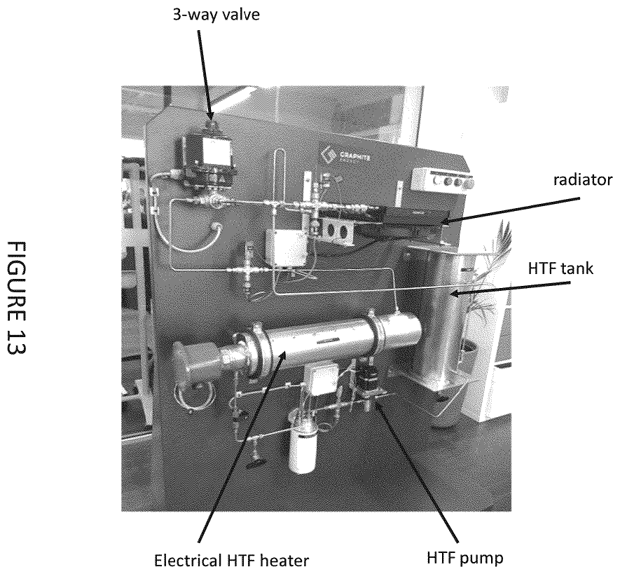

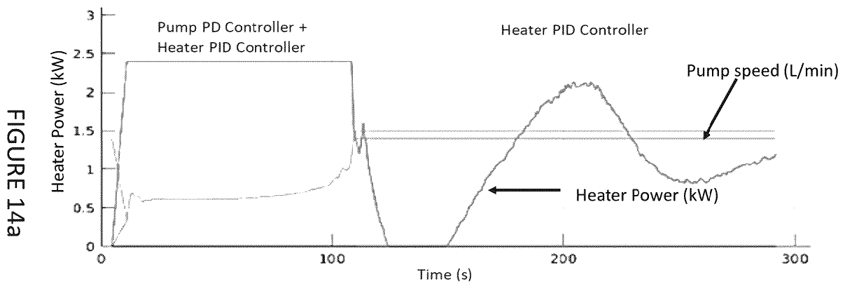

The housing is sealed around the conduit inlets 113, 114 and outlets 117, 118 where they exit the housing through the holes 252, 253, 255, 254 such that air cannot enter the housing after it is sealed. The plurality of openings 251 in the top wall 217 of the housing (as seen in FIG. 8) act as vents during welding together of the wall panels. These vents may be sealed by welding after the rest of the panel has been welded together or they may be used as sealed cable ports for sensors such as thermocouples used to monitor conditions inside the panel in operation, as fill and purge ports to provide argon blanket to graphite core or as filling nozzle to fill void space with graphite powder or other thermally conductive media. Referring to FIG. 10, the only difference when compared with the thermal energy storage panel shown in FIG. 2 with its flat top wall 217, is that the top wall is now curved but this apparatus features curved edges 668, 669 of the top plate, at the interface with the vertical side walls 212, 213, as well as a bellows or boot shaped cover piece 670, 671 located in use to cover at conduit exit interfaces, to reduce zones of high stress. High stress locations were observed during cooling down cycle rather than heating up cycle, at those upper edge locations and at the exit points of the conduits.

After the conduit is fabricated, pre-shaped planks of graphite 509, 512, are positioned to encompass most of the conduits. Referring to FIG. 5, first a lower capping plank 509 is positioned beneath the lowest conduits 440 which extend to the inlets 113, 114.

The lower capping plank 509 is grooved 511 on one (upper) surface with the grooves having a semicircular (or preferably obround) cross-section conforming to the shape and radius of the lowest sections 440 of the conduit. The lower edges 506 of the lower capping plank 509, between the face opposite the grooved surface (i.e., the downward facing surface in FIGS. 5, 6, 7) have a radius corresponding with the transition 271 between the side walls 212, 213 and the base wall 214 of the housing (see, FIG. 8). The edges 506 may have a radius in the range of 50-150 mm and in the proposed embodiment will have a radius of 80 mm.

Referring to FIGS. 5, 6, 7, 9, the bulk of the graphite planks 512 are positioned between the rows of conduits in the tube portions 425, 426, 427. The graphite planks 512 each include two opposite surfaces in which the semicircular (or preferably semi-obround) grooves 511, 516 are formed, conforming to the shape and radius of the conduits of conduit portions 425, 426, 427. When semi-obround grooves are used they are elongated in the vertical direction (i.e., two grooves abut to form an obround cross section with a vertical 10 major axis) to accommodate expansion of the conduit assembly in the vertical direction (as viewed in FIG. 7). Referring to FIG. 9, a partial cross section of two abutting planks 512 shows two pairs of aligned semi-obround grooves (511, 516) encompassing a pair of conduits 426.

Referring to FIG. 8, after the remaining graphite planks 512 are in position a void 802 will remain above planks to accommodate the conduit sections 438, 439. A volume of graphite powder 801 is deposited over the upper tube sections 438, 439 in the void 802 to accommodate expansion and contraction of the housing as the temperature of the assembly changes. The graphite powder may not completely fill the void 802 leaving a small space above the graphite powder 801.

Preferably the abutting surfaces of the graphite planks of FIGS. 5, 6 and 7 will have a surface finish which is N8 or better (ISO 1302). In some embodiments, the abutting surfaces of the graphite planks have a surface finish which is N6, N7, N8, N9 or N10 (i.e., the smaller the number, the finer the finish). Such that when assembled between rows of straight conduit portions adjacent pairs of the planks encompass and closely conform to the respective straight conduit portions and first connecting conduit portions at the internal working temperature of the panel, which is up to 1000° C., the grooves are made approximately 1.6% bigger than the nominal outside diameter of the tubes with a tolerance of approximately +0.00/−1.00%. For example, when the conduits are made from 253MA austenitic stainless steel (any suitable high temperature thermally conductive material such as 800H austenitic steel, 800HT or alloys such as Inconel and Incoloy) and have a nominal outside diameter of 33.4 mm, the grooves will preferably be 33.9 mm (+0.00/−0.25 mm) in diameter. Alternatively, when the conduits are made from the same or similar material and have a nominal outside diameter of 26.67 mm, the grooves will preferably be 27.1 mm (+0.00/−0.25 mm) in diameter and when the conduits have a nominal outside diameter of 42.16 mm, the grooves will preferably be 42.9 (+0.00/−0.25 mm) in diameter. To achieve a high contact surface without excessive expense, the surface of the graphite within the grooves will preferably have a surface finish which is N7 or better (ISO 1302). By maximising the contact of the graphite with the surface of the grooves by designing the grooves to be sized appropriately for the conduit diameter at the working temperature and by providing appropriate surface finish, the operation of the conduit within the graphite is enhanced.

The graphite planks 509, 512, are assembled to encompass the conduit 420, in the open housing, and the locating tube is inserted into the hole 522 extending through all of the planks to maintain alignment. The locating tube may engage a locating pin projecting from the base of the housing (not shown) to locate the graphite core 509, 512, within the housing. The housing is then welded closed, including sealing the openings 255, 254, 252, 253 through which the inlet conduits 113 114 and outlet conduits 117, 118 pass through the housing, to form the finished panel 102 (see, FIGS. 3 and 8). The vent holes 251 may also be sealed either by welding or by inserting scaling plugs or a port fitting that allows sealed passage of transducer cables such as thermocouple wires into the interior of the panel. The vent holes 251 might also be fitted with port fittings to be used as fill ports to provide argon blanket to graphite core or as filling nozzles to fill void space 802 with graphite powder or other thermally conductive media.

Because the graphite planks extend to the ends of the housing and almost fully occupy the space within the housing, the load of the graphite is spread evenly across the bottom wall 214 of the housing, allowing thinner material to be used. Also, by maximising the area of graphite in contact with the walls and consequentially minimising void space, the heat transfer into the graphite by conduction may be maximised. Minimising void space also minimises the amount of trapped air that is available to react with the graphite when the panel is heated to its operating temperature.

In the present embodiment the volume of void spaces within the housing not occupied by graphite or tubing is generally in the range of 4-10% and typically 5-7% of the internal volume of the housing (at the working temperature). Correspondingly the side panel of the housing, which is the irradiated surface of the panel when in use, is generally backed by the graphite core over all but 1-5% of its area and typically 2-3% (at the working temperature) in the preferred embodiment.

In the top wall of the panels, openings 251 allow expansion of the internal air during manufacture and may be welded closed or used as ports. One of the openings 251 is shown with a filling nozzle 163 attached to permit filling of void spaces with graphite powder (refer to description of FIG. 8 below).

FIG. 8 shows a thermal energy storage panel 102 with one side wall removed showing the graphite planks 509, 512, forming the graphite core. Voids will exist between the graphite planks and the walls of the housing (e.g., between the planks 509, 512, visible in FIG. 8 and the vertical walls 212, 213, 215, 216, including the wall 213 which has been removed). A larger void 802 forms a reservoir between the top of graphite core and the top of the housing. The reservoir 802 and the voids in this case are at least partly filled with graphite powder 801. The graphite powder 801 enhances heat transfer between walls of the housing and the graphite core. A filling nozzle 163 is in communication with the reservoir 802 to enable filling of the voids in the housing and topping up of the reservoir 802. The reservoir 802 stores additional graphite powder which prevents spaces opening up when expansion and contraction of the housing and core occur during thermal cycling. This arrangement may be employed in any of the previously described embodiments.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “upper” and “lower”, “above” and “below” and the like are used as words of convenience to provide reference points and are not to be construed as limiting terms.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realise yet other embodiments. Further, each independent feature or component of any given assembly may constitute an additional embodiment.

### Experimental Section

### Example 1—Calculation of Energy Storage Capacities

The energy storage capacity of the thermal energy storage apparatus can be dependent on the operating temperature. The operating temperature can be adjusted based on the thermal (heat) energy transfer fluid used.

The use of a supercritical fluid as a heat transfer fluid effect increases operating temperature range which increases energy storage capacity. Increases in operating temperature can also increase energy storage capacity as the heat capacity of graphite increases with temperature as shown in FIG. 12.

### Energy Storage Capacity

The calculation of energy storage capacity can be calculated from FIG. 12 which shows the dependency of thermal energy storage on average graphite temperature.

For example, if steam was used which typically provides an operating temperature of 400° C. to 600° C., the energy stored by graphite at that temperature range is 110 kWht/tonne of graphite. This is calculated from FIG. 12, where the energy storage of graphite at 600° C. is about 280 kWht/tonne of graphite and at 400° C. is about 170 kWht/tonne of graphite. The difference in energy storage at these two temperatures is therefore 110 kWht/tonne of graphite.

If a supercritical fluid such as sCO₂ was used which typically provides higher operating temperatures compared to steam, the energy stored by graphite at an operating temperature of 700° C. to 900° C. is 130 kWht/tonne of graphite. This is calculated from FIG. 12, where the energy storage of graphite at 900° C. is about 480 kWht/tonne of graphite and at 700° C. is about 350 kWht/tonne of graphite. The difference in energy storage at these two temperatures is therefore 130 kWht/tonne of graphite.

### Energy Conversion Efficiencies

The energy produced during discharging can then be determined by the type of energy generator used, such as steam power generation or supercritical fluid generation (as in Brayton cycle generators using sCO₂).

The theoretical power conversion efficiency of a steam power generator is about 36% and the theoretical power conversion efficiency of a supercritical fluid generator is 45%.

As such, for steam power generation operating between 400° C. to 600° C., energy conversion is 40 kWhe/tonne (110 kWht/tonne of graphite×36% efficiency).

For supercritical fluid generation operating between 700° C. to 900° C., energy conversion is 59 kWhe/tonne (130 kWht/tonne of graphite×45% efficiency).

It can therefore be seen that supercritical power generation is greater than steam power generation due to higher operating temperatures and improved efficiencies of Brayton cycle generators compared to steam powered generators. For the example calculation above, the sCO₂ power generating potential per tonne of graphite is 47% higher than for steam power generation (59 kWhe/tonne/40 k Whe/tonne×100%).

### Example 2—Optimising Transfer of Thermal Energy from High Temperature Fluid to the Graphite Solid Material

An apparatus using a pumped circuit or loop of electrically heated heat transfer fluid (HTF) was developed to optimise the charging of the thermal energy storage apparatus with HTF to minimise charge time while avoiding overheating. An exemplary embodiment was built as well as CAD variants as shown in FIG. 13. In this instance, a fan-forced, air-cooled radiator was chosen to mimic the thermal energy storage apparatus as it enables measurement and control the amount of heat dissipated. The HTF will typically be electrically heated using otherwise curtailed generation from solar photovoltaics and/or wind plants behind the meter.

The thermal energy storage apparatus is suitable for renewable energy generators to store and use energy as required. The thermal energy storage apparatus of the present invention is designed to match the requirements of the emerging Bryton Cycle generators using supercritical CO₂ (sCO₂). The thermal energy storage apparatus can be charged (heated up) using electrically heated HTF up to 800° C.

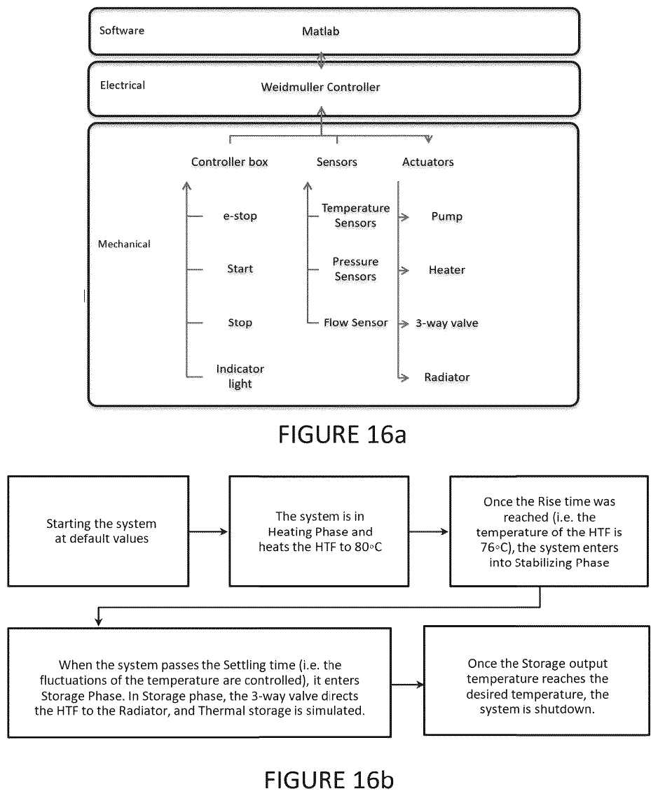

The control software to operate the thermal energy storage apparatus was developed using Matlab as shown in FIG. 16. HTF flow and heating control functions were tuned with two different PID strategies. These were,

Strategy 1. Cascaded PID: 2 separate PIDs were used, one for the Pump and one for the Heater. The Heater PID was always active while the pump PID was activated only when the heater power reached its maximum heating capacity.

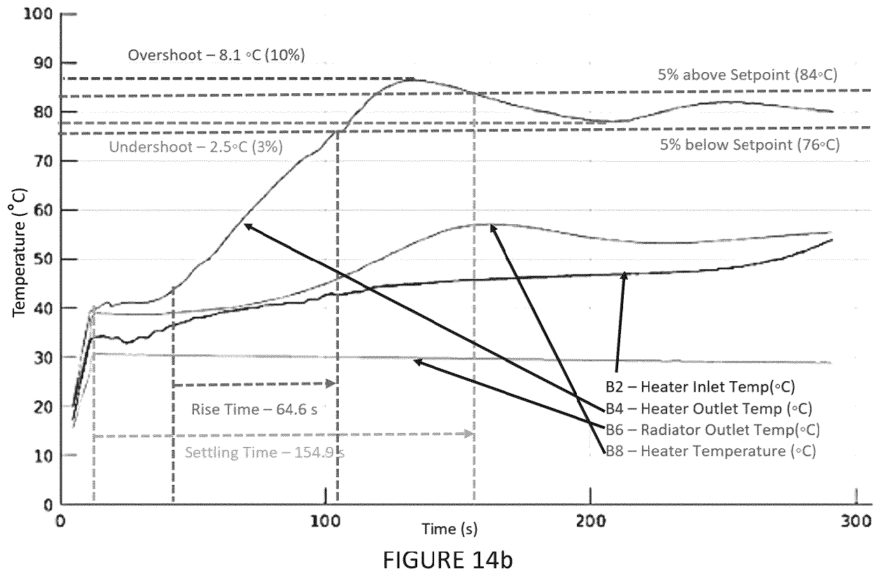

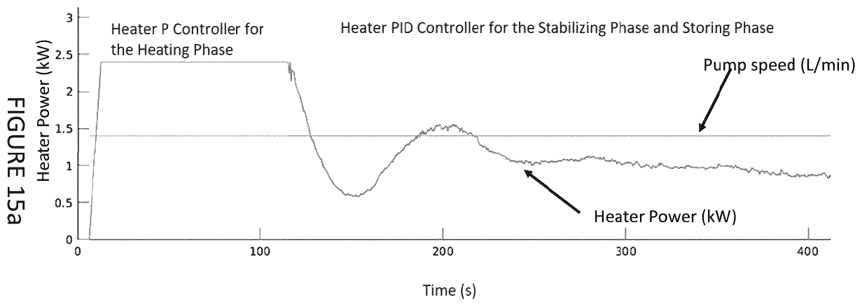

For strategy 1, the PIDs were used for controlling the heating rate of the heater and the flow of the pump to control the rise time, settling time and the overshoot of the B4 Temperature. The heater PID is always active, and the pump PID is activated when the heater power reaches its maximum. This is to stabilize B4 Temperature even when the parts reach its maximum capacity. The actuator behaviour and temperature response for strategy 1 is shown in FIG. 14.

For strategy 1, the control range of the pump speed can be limited i.e., From 0.5 L/min to 1.4 L/min which leads to limited control of heat transfer during the Pump PID. This limitation led to a 10% overshoot.

Strategy 2. PID based on the operation phase: 2 PIDs were implemented for the heater, where the PID switches were based on the operating phase. Throughout the operation, the pump speed is set to maximum.

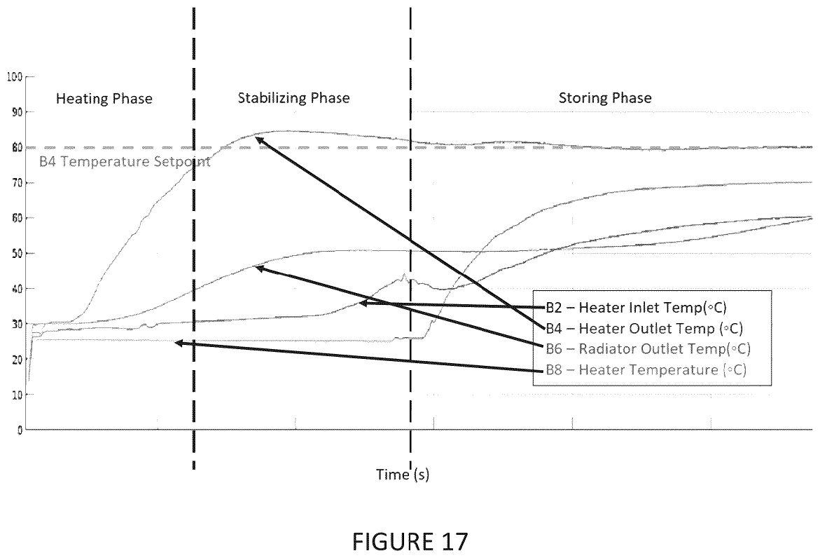

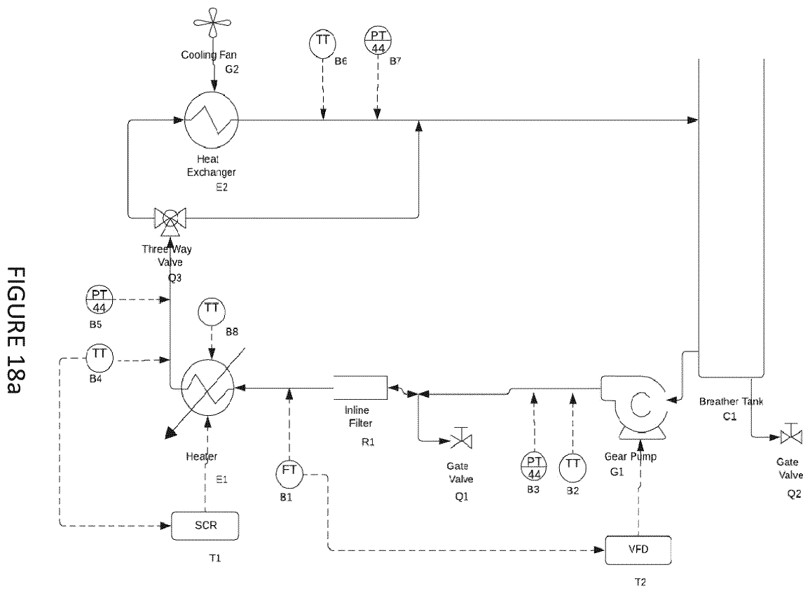

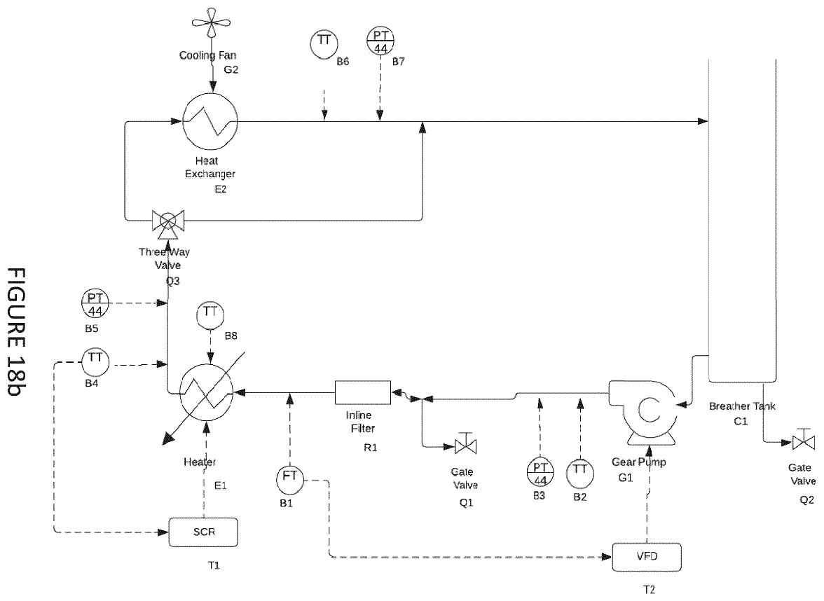

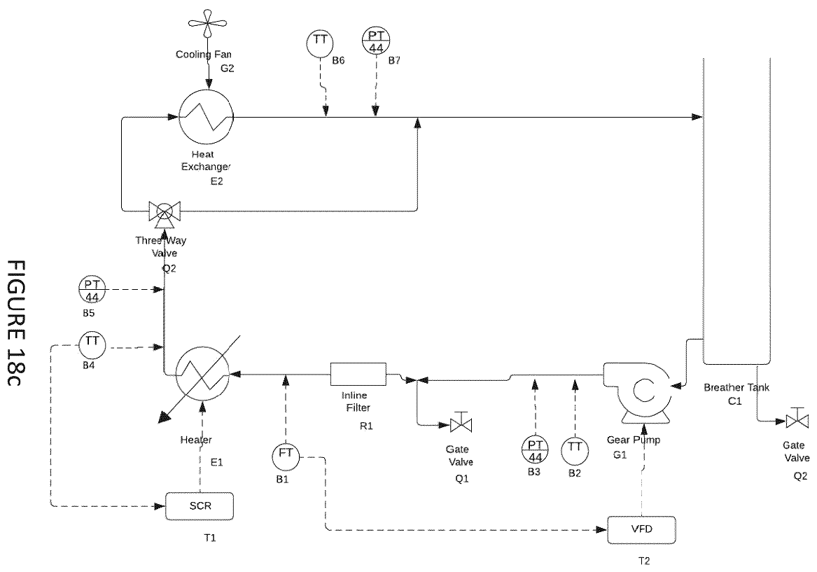

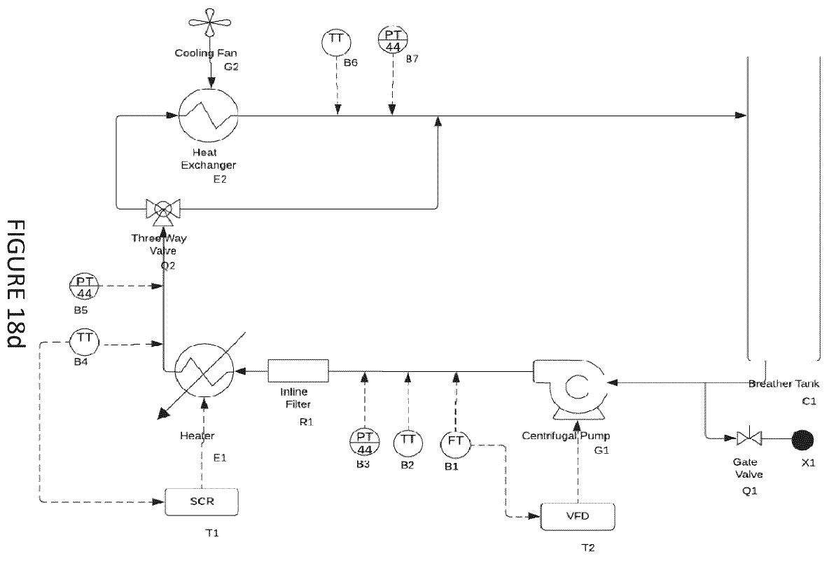

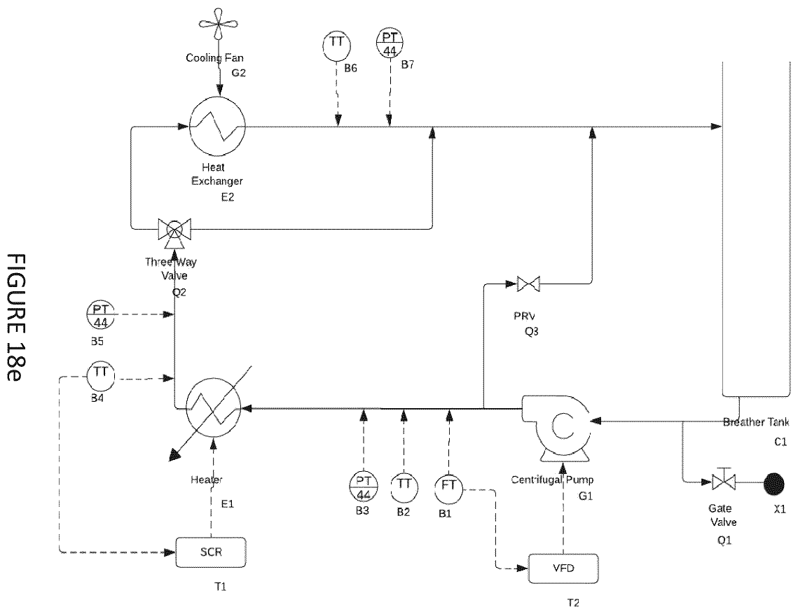

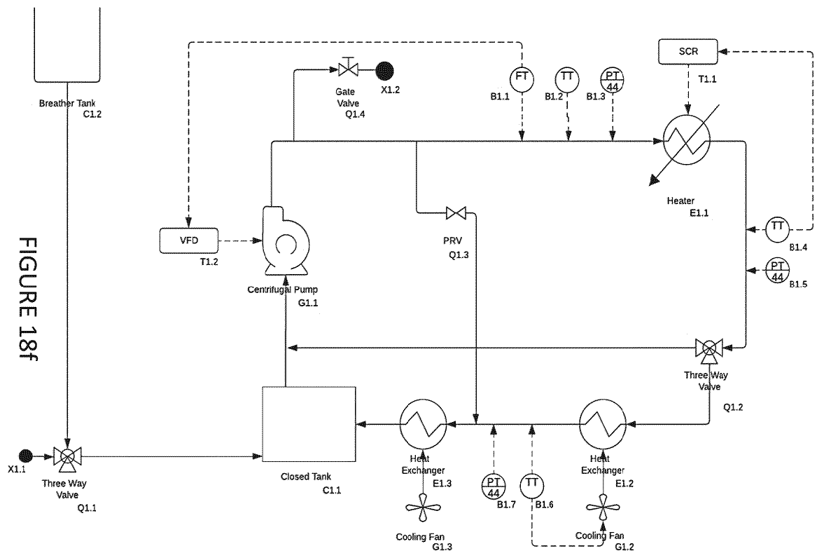

Strategy 2 was developed to address issues with strategy 1. In strategy 2, the heater has two different PIDs based on the phase that it is operating. The first controller is activated during the heating phase, and the second controller during the stabilizing and storing phase as shown in FIG. 17.

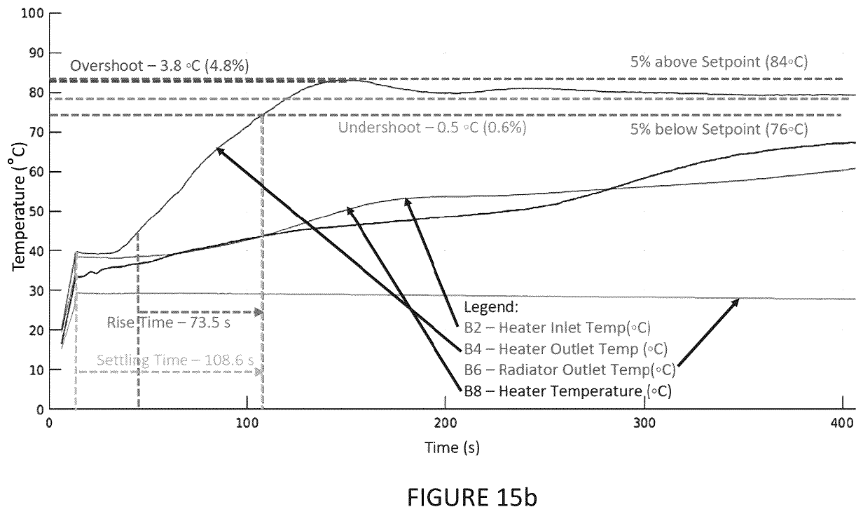

The pump rate is set to maximum (for example, 1.4 L/min) at all the phases as the heat circulation in the HTF is higher when the pump rate is at maximum. The actuator behaviour and temperature response for Strategy 1 is shown in FIG. 15.

A proportional-integral-derivative controller (PID controller or three-term controller) is a control loop mechanism employing feedback that is widely used in industrial control systems and a variety of other applications requiring continuously modulated control. A PID controller continuously calculates an error value as the difference between a desired setpoint (SP) and a measured process variable (PV) and applies a correction based on proportional, integral, and derivative terms (denoted P, I, and D respectively).

Strategy 2 typically provided desired results with lower overshoot and lower settling time. The present Applicant surprisingly found that: when the pump flowrate was increased, the overshoot and the undershoot was reduced due to the increase in heat transfer within the HTF which provided better control over its temperature; when the HTF is pumped through the radiator at a low flowrate, the cooling rate was increased due to increase in contact time, and having the least volume of HTF in the system took the least time to heat up and cool down. This relates to the specific heat formula Q=mcΔT (equation 1), wherein when mass increases, the energy needed to heat the HTF also increases. Q is the energy transfer, m is mass of a substance, c is the specific heat, ΔT is the change in temperature.

A comparison of strategies 1 and 2 is shown in Table 1, below.

TABLE 1
Strategy outcome comparison

| Properties | Strategy 1 | | Strategy 2 | | Change |
|---|---|---|---|---|---|
| Rise Time | 64.6 | s | 73.5 | s | increased by 13.7% |
| Overshoot | 8.1° C. (10%) | | 3.8° C. (4.8%) | | decreased by 53% |
| Undershoot | 2.5° C. (3%) | | 0.5° C. (0.6%) | | decreased by 80% |
| Settling Time | 154.9 | s | 108.6 | s | decreased by 30% |

Although the rise time in strategy 2 increased, the other properties improved. An important factor is the settling time; all the heated energy in the HTF before reaching the setpoint is not stored in the thermal energy storage apparatus and is directed to the tank. Use of strategy 2 was typically more preferred.

The main limitation of this system in FIG. 15b is that the pump flowrate could not exceed 1.4 L/min even though it has a rated flowrate of 3.5 L/min. This is due to the size of pump inlet conduit being the same as the size of outlet conduit, thereby choking the pump prematurely. The pump flowrate was therefore capped at 1.4 L/min causing the system's heating time, cooling time and the shutting downtime to be longer than would otherwise occur for a higher pump flowrate.

In some instances, there can be a delay between the code execution and the response from the actuator components in the system. These are due to the multiple classes and libraries used in Matlab. However, use of an industrial system can likely reduce these issues.

In the proof-of-concept system of Example 2, the system may not have enough power to start all the components in the system all at once. When they are started at once, the system can momentarily lose energy and stop operation. For uninterrupted operation, the components are started sequentially.

When the pump flowrate was increased, the overshoot and the undershoot was reduced as the heat circulation in the HTF increased with the flowrate, and the temperature difference between the heater and the radiator inlet was minimised. Hence the PID settling time was reduced with high flowrate.

The cooling rate of the radiator increased when flowrate decreased as the energy extraction from the HTF increased with the increased contact time.

Having a lower volume of HTF in the system reduces the time to heat up and cool down. When the volume increases, the energy needed to raise that mass to the desired temperature also increases. Since the capacity of the heater to supply energy is limited, the time taken to achieve the target temperatures increases. Using less HTF in the thermal energy storage apparatus is typically more efficient as the energy used in the heating phase and stabilizing phase is reduced.

The heating time, cooling time and the shutting downtime can be adjusted depending on the following factors: use of a pump with higher flowrate range; selecting an inlet conduit and fitting bore size of the pump to be larger (at least 50%) than the pump outlet conduit size; use of minimal HTF volume in the thermal energy storage apparatus; and implement the software in an industrial system with dedicated computer and wired connections. The thermal energy storage apparatus can also be optimised including: adjusting the pump inlet conduit radius to be at least twice the radius of the pump outlet conduit to balance the mass flow between the pump inlet and outlet conduits at higher flowrates without damaging the pump; using a pump with a larger flowrate range than required; using minimal HTF volume in the thermal energy storage apparatus as possible; avoiding starting the system components simultaneously as the system may not be able to supply the necessary current and using time gaps between the component start-ups to manage the power consumption of the system; and implementing the software in an industrial system with a dedicated computer to avoid communication delay and cut-offs. Preferably, the computer would be using wired connections to improve the stability of communication.

Example 2 was a proof-of-concept and as such for analysis, the HTF was heated to 80° C. to minimise risk and ensure safety during testing.

### Thermal Energy Storage Apparatus Operation

FIG. 16a shows how the controller typically controls the thermal energy storage apparatus according to the instructions sent from the Matlab code and FIG. 16b shows a flow chart of the operating process.

TABLE 2
Identifiers, part type and purpose

| Identifier | Part Type | Purpose |
|---|---|---|
| B1 | Flow Transmitter | To measure the flowrate of the HTF in the conduits. |
| B2 | Temperature | Used to measure the temperature of the HTF before |
| | Transmitter | heating. |
| B3 | Pressure Transmitter | To monitor the pressure in the conduits. |
| B4 | Temperature | Used to measure the temperature of the heated HTF. |
| | Transmitter | |
| B5 | Pressure Transmitter | To monitor the pressure in the conduits. |
| B6 | Temperature | To measure the temperature of the HTF leaving E2. |
| | Transmitter | |
| B7 | Pressure Transmitter | To monitor the pressure in the conduits. |
| B8 | Temperature | To monitor the temperature inside the heater. |
| | Transmitter | |
| C1 | Open Tank | For storing the HTF. A sight glass is used to monitor |
| | | the HTF in the tank. |
| E1 | Heater | Used to heat the HTF to the desired temperature. |
| E2 | Radiator/Heat | Acts as a Thermal Energy Storage Unit. It absorbs |
| | Exchanger (conduit) | the heat from the HTF. |
| G1 | Pump | Used to pump the HTF throughout the system. |
| G2 | Fan | This cools the Heated Fluid in the E2. |
| Q1 | Valve | To drain the HTF from the system. |
| Q2 | Valve | To drain the balance HTF from the tank. |
| Q3 | 3-way Valve | To bypass the HTF based on its temperature. |

When the thermal energy storage apparatus is started, it immediately enters the heating phase. The default values of the actuators are: the pump is switched on, at speed=0 L/min; the heater is at duty-period of 5 seconds with 0% duty-cycle; the 3-way valve is opened, and the HTF is bypassing the radiator to the tank; and the radiator is then switched off.

When the thermal energy storage apparatus enters the shutting down phase, the system runs the radiator and the pump at their maximum speed to cool down the HTF in the thermal energy storage apparatus to 40° C. The heater is at the duty-cycle of 0%, and the 3-way valve is directing the HTF towards the radiator.

The PID tuning was completed after multiple test runs with different P, I and D constants. The system was cooled down to a constant temperature to get consistent initial conditions.

FIG. 17 shows a typical temperature behaviour during different phases of the software during operation of the thermal energy storage apparatus.

In respect of conduit and instrumentation diagrams, abbreviations and their parts are described in Table 2, above.

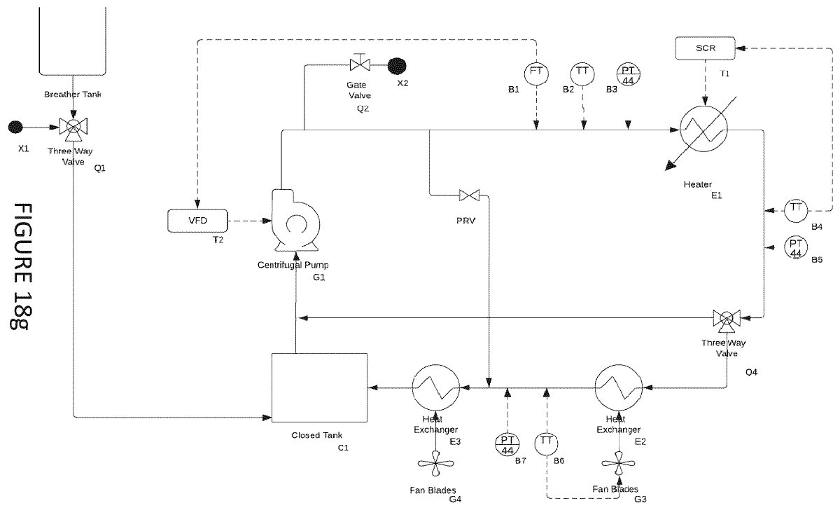

One embodiment of a conduit and instrumentation diagram for a thermal energy storage apparatus and the system process is shown in FIG. 18a. The HTF from the tank (C1) primes the pump (G1) by gravity. When the pump is active, the HTF passes through a set of temperature (B2) and pressure (B3) sensors and reaches the oil filter (R1). Then through the flow sensor (B1), it enters the heater (E1) and is heated. The heater has an internal temperature sensor (B8) which gives the average temperature reading of the HTF in the heater. After exiting the heater, the HTF passes through another set of temperature (B4) and pressure (B5) sensors, and it reaches the 3-way valve (Q3). By default, the valve directs the HTF towards the tank.

When the HTF temperature reaches the setpoint (at the B4 temperature sensor), the valve directs the HTF through the radiator (E2 and G2). The radiator in this system simulates the behaviour of a thermal energy storage apparatus by absorbing the heat from the HTF. After exiting the radiator, the HTF goes through another set of temperature (B6) and pressure (B7) sensors and returns to the tank. When the radiator outlet temperature reaches its maximum, the system considers the thermal energy storage apparatus as charged, and the system shuts down. During the shutdown period, the pump and the radiator speed is at maximum while the heater is switched off as the system cools down to a safe temperature.

The following lists the design considerations of variation I: the 3-way valve is used to bypass the HTF with the temperature below the set point temperature. When HTF with a temperature lower than the storage temperature is passed through the thermal storage tank, it discharges the thermal energy storage apparatus can result in an inefficient storage system; the system was made to be an open system. This eliminates the need to manage the internal pressure of the system due to the changes in the volume of the HTF when it goes through temperature changes; the draining valve (Q1) is at the lowest point of the system and drains the HTF through gravity as required; the arrangement of the B1 (flow) sensor, the (pump-outlet pressure) B3 sensor and (temperature) B2 sensor allows the user to observe whether the inline filter is blocked or not (that is, if the B1 flow reading drops drastically below the set pump rate and the B3 pressure reading is increasing more than the rest of the system, it can be concluded that there is a blockage in-between the B3 sensor and the B1 sensor. As such, the blockage can be detected); the tank-outlet conduit for this system is around 100 mm higher than the lowest point.

The setup allows the system to utilize oil free of dust and dirt particles as the dust settles at the bottom of the tank; addition of a separate draining valve for the tank (Q2) allows the user to drain the tank separately such that the dust particles in the system is drained without mixing it with the rest of the oil.

FIGS. 13 and 18a is the least risk desktop system in terms of safety and hazards. The initial safety considerations for FIGS. 13 and 18a are: the temperature setpoint is 1/10th of the final system; internal pressures are avoided by making it open to the atmosphere; lower risk HTF is used compared to the other options such as sCO₂/liquid metal; and the electrical equipment used 12 to 24 V DC current.

Alternate embodiments of a conduit and instrumentation diagram for a thermal energy storage apparatus and the system process is shown in FIG. 18.

For the embodiment of the conduit and instrumentation diagram (FIG. 18d), the B1 (flow) sensor, the (pump-outlet pressure) B3 sensor and (temperature) B2 sensor were rearranged. This re-arrangement allowed the user to observe if the inline filter is blocked or not. This can be done by monitoring the behaviour of the B1 sensor and the B3 sensor. That is if the B1 reading drops drastically below the set pump rate and the B3 reading is increasing more than usual, there may be a block in-between the B3 sensor and the B1 sensor. Addition of a separate draining valve for the tank and the tank-outlet of this system (FIG. 18d) is around 100 mm higher than the lowest point. This setup allows the system to utilize the oil-free dust and dirt particles from the system as the dust settles in the tank.

For the embodiment of the conduit and instrumentation diagram (FIG. 18f), the cooling system that cools the HTF which enters the tank was removed. The cooler cools down the HTF after exiting the storage even during the battery storage phase. This leads to drastic energy waste, and the cooler was only used when shutting down the thermal energy storage apparatus after completely charging the thermal energy storage apparatus.

TABLE 3
Potential failure modes of the thermal energy storage apparatus

| Failure Modes | Symptoms | Causes |
|---|---|---|
| Power failure | The system stops completely | Blown Fuse |
| E1 not | The HTF is cooled down, also inducing heat loss | Blown Fuse; Faulty |
| heating/working | in the storage | sensor (B1, B2 or |
| | | B4); Communication |
| | | failure |
| G1 faulty | Overheating the HTF which might result in phase | Blown fuse; |
| | change and build pressure in the system. This | Communication |
| | might result in an explosion and fire | failure |
| Faulty | The heating rate in the E1 is affected and ends up | Faulty connections; |
| temperature | in either the cooling mode of E2 or overheating the | Requires calibration |
| sensors (B2, B4, | HTF in the E1 leading to accidents. | |
| B6) | | |
| Faulty flowrate | G1 is adjusted by B1 to get the desired flowrate. | Faulty wire |
| sensor (B1) | The heating rate in E1 is affected and ends up in | connections; |
| | either the cooling mode of the storage system or | Requires calibration |
| | overheating the HTF in the heater leading to | |
| | accidents. | |
| Faulty pressure | The readings indicate danger mode when it is still | Faulty wire |
| sensors (B3, B5, | normal pressure, which results in an unnecessary | connections; |
| B7) | shutdown of the system. It may also indicate | Requires calibration |
| | normal when there is high pressure in the system | |
| | which may result in explosions/leaks | |
| Faulty Valves | HTF could leak into the environment, which could | Wear and tear |
| (Q1, Q2) | be a reactive fluid at a higher temperature. | |
| Faulty cooler | System shutting down process will be delayed as | Blown Fuse; |
| (G3) | the cooling process will be due to natural | Communication |
| | convection than the forced convection from the | failure |
| | cooler | |
| Faulty | HTF cools down or heats up undesirably and cause | Blown Fuse; |
| controllers (T1, | accidents. | Communication |
| T2) | | failure |

Lowering the drain valve to the lowest position of the thermal energy storage apparatus enables the whole system to drain by gravity. The pressure release valve (PRV) is not necessary as the system specification has been changed by reducing the maximum system pressure from 10 bar to 3 bar in this embodiment.

For the embodiment of the conduit and instrumentation diagram (FIG. 18h), the closed system was configured into an open system. The reason for this is when the closed system was configured into an open system, the need to manage the internal pressure was avoided which allows the development of the thermal energy storage apparatus to be less complicated. The pump-outlet line was connected to the heater inlet using a line, and a pressure release valve (PRV) is added to the line (removed in some embodiments). This PRV line manages the excess pressure generated by the pump. This line bypasses excess fluids to the tank and stabilizes the pressure when it exceeds the set limit.

For the embodiment of the conduit and instrumentation diagram (FIG. 18i), the 3-way valve was added to create a bypass for the HTF when it is not heated enough to the desired storage temperature.

The reason for this is when the HTF with a temperature lower than the storage temperature is passed through the thermal storage, the HTF can discharge the battery and results in an inefficient thermal energy storage apparatus. With the 3-way valve, the thermal energy storage apparatus can bypass lower temperature HTF without entering the thermal storage.

For the different embodiments, the HTF had an equal or higher skin temperature than is recommended for the heater which is 0.031 W/mm² (20 W/in²), and the boiling point should be higher than 80° C. HTF (therminol 66) with a maximum heating rate of 0.031 W/mm² (20 W/in²) and boiling point of 359° C. was used in Example 2.

### i) Pump Speed Variation

The pump speed can be varied which can affect the temperature differences of the thermal energy storage apparatus as shown in Table 4, below.

The variation of pump speed can affect the temperature difference of the HTF (with a maximum heating power). For temperature differences of 60° C. to 10° C., a pump with a flowrate of 1.4 L/min to 8.7 L/min is preferable. Since the heater power can be controlled, a readily available pump with 0.5 L/min to 3.5 L/min was selected for the system to be operated with various heater powers.

TABLE 4
Pump speed variation on temperature difference

| Temperature | | | HTF | cp @ | |
|---|---|---|---|---|---|
| T fin | T bulk | Q | rho @ T | T bulk | |
| (C.) | (C.) | (KW) | bulk (kg/L) | (J/kg/K) | |
| 80 | 50 | 2.4 | 0.988 | 1660 | |
| 80 | 55 | 2.4 | 0.988 | 1660 | |
| 80 | 60 | 2.4 | 0.988 | 1660 | |
| 80 | 65 | 2.4 | 0.988 | 1660 | |
| 80 | 70 | 2.4 | 0.988 | 1660 | |
| 80 | 75 | 2.4 | 0.988 | 1660 | Continued |

| v @ | | k @ | Pump specification | |
|---|---|---|---|---|
| T bulk | Pr @ | T bulk | V/t | |
| (m²/s) | T bulk | (W/m/K) | (L/min) | m/t (kg/s) |
| 17.6E−6 | 252 | 0.1163 | 1.4633 | 0.0241 |
| 17.6E−6 | 252 | 0.1163 | 1.7560 | 0.0289 |
| 17.6E−6 | 252 | 0.1163 | 2.1950 | 0.0361 |
| 17.6E−6 | 252 | 0.1163 | 2.9267 | 0.0482 |
| 17.6E−6 | 252 | 0.1163 | 4.3900 | 0.0723 |
| 17.6E−6 | 252 | 0.1163 | 8.7801 | 0.1446 |

### ii) Conduit Size Variation

The conduit size can be varied which can affect the flow type of the thermal energy storage apparatus as shown in Table 5.

TABLE 5
Variation of the flow type for different conduit sizes

| Temperature | | | Conduits | | | | | | |
|---|---|---|---|---|---|---|---|---|---|
| T in | T fin | T bulk | L | k | OD | Wall | OD | ID | |
| (C.) | (C.) | (C.) | (m) | (W/m/K) | (in) | (in) | (m) | (m) | |
| 20 | 80 | 50 | 0.6 | 16.3 | ⅛ | 0.028 | 0.003175 | 0.0018 | |
| 20 | 80 | 50 | 0.6 | 16.3 | ¼ | 0.035 | 0.00635 | 0.0046 | |
| 20 | 80 | 50 | 0.6 | 16.3 | ¼ | 0.049 | 0.00635 | 0.0039 | |
| 20 | 80 | 50 | 0.6 | 16.3 | ¼ | 0.065 | 0.00635 | 0.0030 | |
| 20 | 80 | 50 | 0.6 | 16.3 | ⅜ | 0.035 | 0.009525 | 0.0077 | |
| 20 | 80 | 50 | 0.6 | 16.3 | ⅜ | 0.049 | 0.009525 | 0.0070 | |
| 20 | 80 | 50 | 0.6 | 16.3 | ⅜ | 0.065 | 0.009525 | 0.0062 | |
| 20 | 80 | 50 | 0.6 | 16.3 | ½ | 0.035 | 0.0127 | 0.0109 | |
| 20 | 80 | 50 | 0.6 | 16.3 | ½ | 0.049 | 0.0127 | 0.0102 | |
| 20 | 80 | 50 | 0.6 | 16.3 | ½ | 0.065 | 0.0127 | 0.0094 | Continued |

| Conduits | | Pump spec | | HTF | | | | |
|---|---|---|---|---|---|---|---|---|
| Ac | As | V/t | m/t | rho | cp | v | | |
| (m2) | (m2) | (L/min) | (kg/s) | (kg/L) | (J/kg/K) | (m2/s) | Pr | |
| 2.41E−06 | 0.0033 | 2.1950 | 0.0361 | 0.988 | 1660 | 17.6E−6 | 252 | |
| 1.64E−05 | 0.0086 | 1.4633 | 0.0241 | 0.988 | 1660 | 17.6E−6 | 252 | |
| 1.17E−05 | 0.0073 | 1.4633 | 0.0241 | 0.988 | 1660 | 17.6E−6 | 252 | |
| 7.30E−06 | 0.0057 | 1.4633 | 0.0241 | 0.988 | 1660 | 17.6E−6 | 252 | |
| 4.71E−05 | 0.0146 | 1.4633 | 0.0241 | 0.988 | 1660 | 17.6E−6 | 252 | |
| 3.89E−05 | 0.0133 | 1.4633 | 0.0241 | 0.988 | 1660 | 17.6E−6 | 252 | |
| 3.04E−05 | 0.0117 | 1.4633 | 0.0241 | 0.988 | 1660 | 17.6E−6 | 252 | |
| 9.37E−05 | 0.0206 | 1.4633 | 0.0241 | 0.988 | 1660 | 17.6E−6 | 252 | |
| 8.19E−05 | 0.0192 | 1.4633 | 0.0241 | 0.988 | 1660 | 17.6E−6 | 252 | |
| 6.94E−05 | 0.0177 | 1.4633 | 0.0241 | 0.988 | 1660 | 17.6E−6 | 252 | Continued |

| HTF | | | | |
|---|---|---|---|---|
| k | Q | qs | | Flow |
| (W/m/K) | (kW) | (kW/m2) | Re. | Flow type |
| 0.1163 | 2.4 | 726.49 | 1,507.09 | Laminar |
| 0.1163 | 2.4 | 278.49 | 385.14 | Laminar |
| 0.1163 | 2.4 | 329.79 | 456.09 | Laminar |
| 0.1163 | 2.4 | 417.73 | 577.72 | Laminar |
| 0.1163 | 2.4 | 164.35 | 227.30 | Laminar |
| 0.1163 | 2.4 | 180.97 | 250.27 | Laminar |
| 0.1163 | 2.4 | 204.60 | 282.96 | Laminar |
| 0.1163 | 2.4 | 116.58 | 161.22 | Laminar |
| 0.1163 | 2.4 | 124.70 | 172.45 | Laminar |
| 0.1163 | 2.4 | 135.48 | 187.37 | Laminar |

When the HTF was heated using a trace heating configuration, turbulent flow was preferred to increase the heat flow. When the HTF was heated using a shell and tube configuration, laminar flow was preferred to avoid heat loss from the thermal energy storage apparatus.

Based on the heat transfer properties, having laminar flow in the conduits has less heat transfer compared to transient or turbulent flow as the transient or turbulent flow induces heat transfer. Since the heat loss from the conduits should be minimised, laminar flow is preferable. Another factor considered in Example 2 was the volume of the HTF in the thermal energy storage apparatus as having less HTF in the system reduces heating and cooling time. The selected pump's inlet outer diameter (OD) is ⅛ inch (˜0.3 cm), hence the conduit needs to have larger OD to facilitate a smooth flow. A ¼ inch (˜0.6 cm) OD conduit was preferred for Example 2.

From the ¼ inch (˜0.6 cm) conduit range, the conduit sizing with minimum wall thickness was chosen for ease of manufacturing as the conduits were bent with a hand pipe bender.

### Example 3—Modelling of the Thermal Energy Storage Apparatus

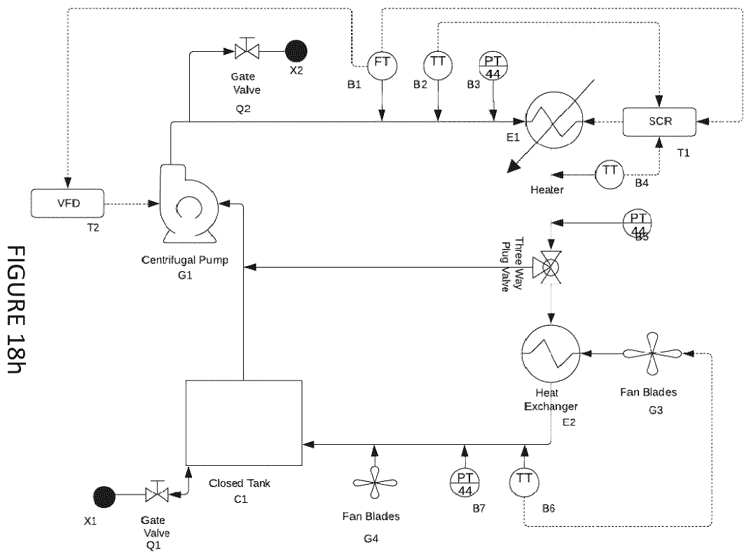

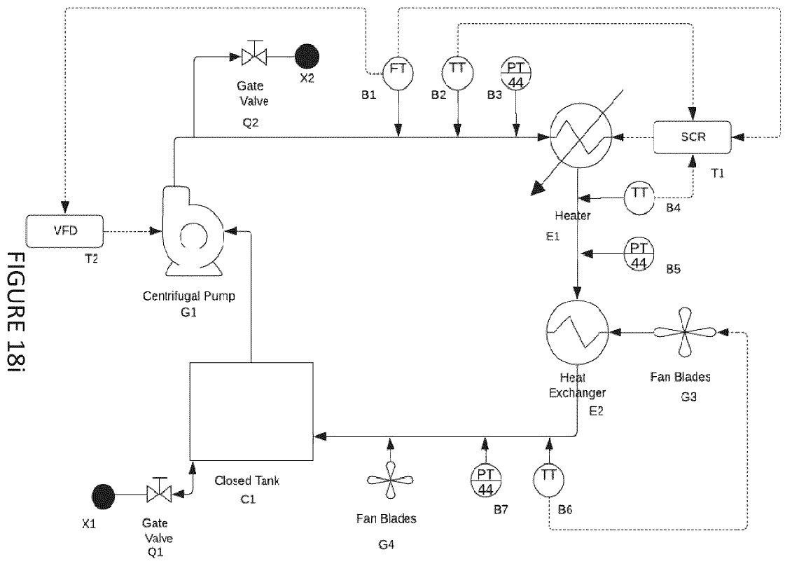

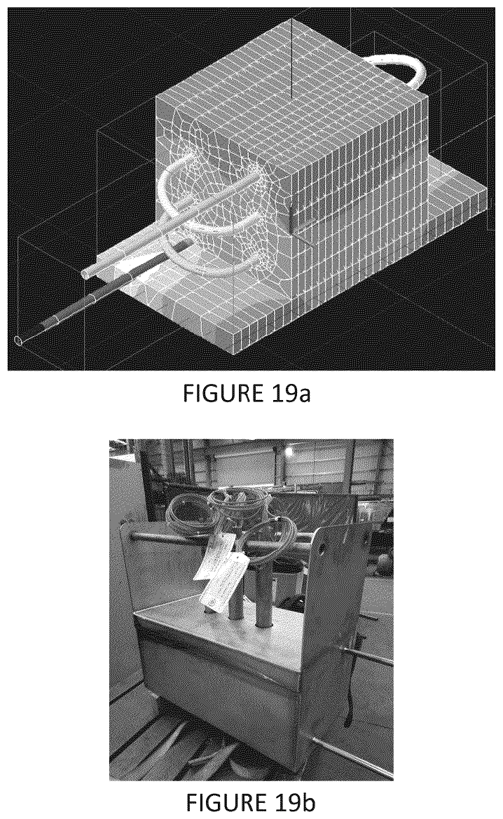

The thermal energy storage apparatus of the present invention (such as in FIGS. 2 and 6) were modelled for higher operating temperatures at 800° C. as Example 2 uses a HTF temperature of 80° C. for safety considerations and initial prototyping. Modelling was developed using Autodesk® Inventor 3D model. The geometry was simplified and mesh generated in SpaceClaim. The thermo-hydraulic model was developed using Thermal Desktop®. This suite of software is developed and maintained by CandR Technologies. The model and prototype for use with a liquid sodium heat transfer fluid is shown in FIGS. 19a and 19b, respectively.

The following assumptions were made: only the graphite and conduit have been modelled; the graphite has been assumed to be a single mass (i.e., no separate blocks), as such interfaces between horizontal layers of graphite have not been included. Given previous modelling experience of similar assemblies this is shown to be negligible; no heat loss from the casing has been considered, heat loss will have minimal impact on determining suitable test conditions; internal sections of the graphite that have been removed for instrumentation have not been modelled due to increased complexity of the mesh and heat transfer boundary conditions; no heat tracing has been included; it is assumed the heat tracing will be temporarily turned off while the test runs are undertaken; pressure drop was measured, however was determined to be negligible in the model; the model used 253MA conduit material properties, but can include Inconel 625, and the contact heat transfer coefficient at the conduit-to-graphite interface is set at 400 W/m²/° C. which is based on a G2 Thermo-Hydraulic Model by Dr David Reynolds PhD, MBA, BE Mech. (Hons) Rev 1.0 17 Nov. 2014. A sensitivity assessment was undertaken to validate this value of 400 W/m²/° C. The contact heat transfer coefficient is an important variable to assess during verification of the model.

The sensitivity assessment was used to confirm that a 0.01-0.05 kg/s flow rate and 300-800° C. temperature range is suitable. The sensitivity of the model was assessed against the contact heat transfer coefficient between the conduit and graphite (as this was an important variable to validate).

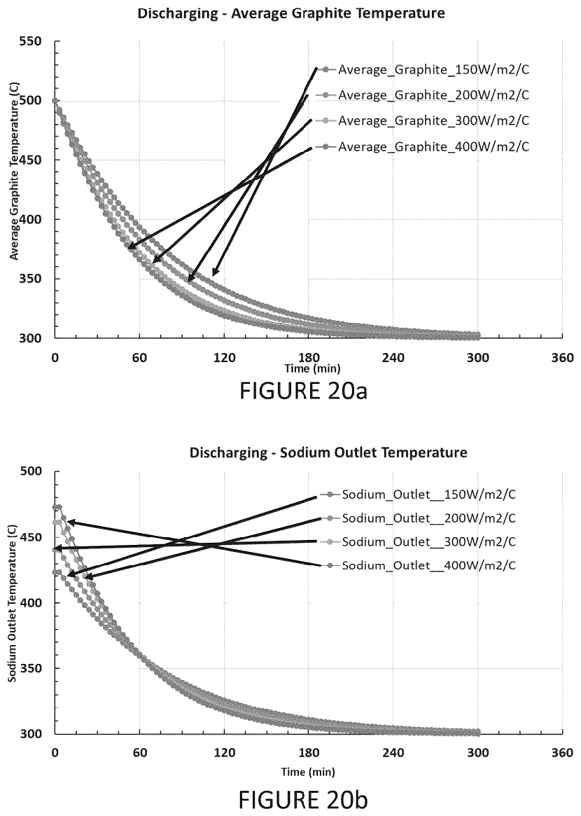

The results of the sensitivity assessment as shown in FIG. 20 is for 0.02 kg/s flow rate and a 300-500° C. temperature range which confirmed that the flow rates and temperature ranges are suitable.

The following input data were considered in the model: Graphite material properties based on CSIRO “Thermal Properties of Commercial Graphite” Test Reports by Steven Wright (2010/2011); 253MA Conduit Material Properties based on the Sandvik Datasheet (2019); Liquid Sodium Material Properties; Thermal Desktop materials library.

The following boundary conditions were considered in the model: HTF was limited to liquid sodium; Pressure set at 2 bar for a time of 300 min; HTF Flow Rate: Various fixed flow rates from 0.01 kg/s to 0.1 kg/s; HTF Inlet temperature (Charging): 800° C. or 500° C.; HTF Inlet Temperature (Discharging): 500° C. or 300° C.; Initial average Graphite Temperature (Charging): 500° C. or 300° C., and; Initial Average Graphite Temperature (Discharging): 800° C. or 500° C.

The outputs of the model were the average graphite temperature and the HTF outlet temperature of the thermal energy storage apparatus.

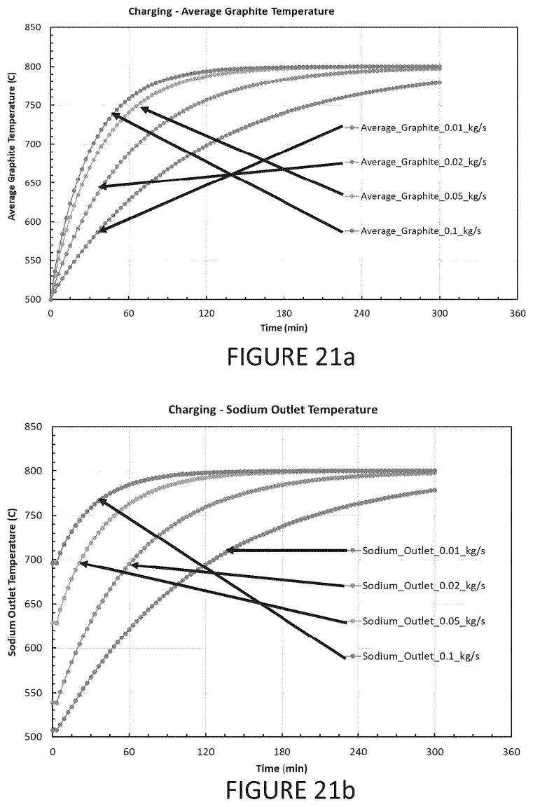

For the scenario during the charging phase, using an average graphite temperature of 500° C., a sodium inlet temperature of 800° C., varying sodium inlet flow from 0.01 to 0.1 kg/s and a run time of 300 minutes, the average charging graphite temperature and sodium outlet temperature is shown in FIG. 21.

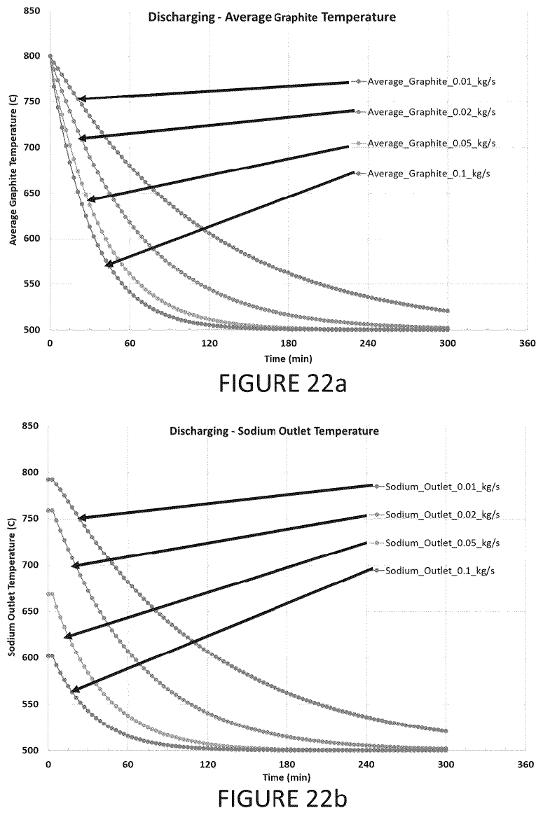

For the scenario during the discharging phase, using an average graphite temperature of 800° C., a sodium inlet temperature of 500° C., varying sodium inlet flow from 0.01 to 0.1 kg/s and a run time of 300 minutes, the average charging graphite temperature and sodium outlet temperature is shown in FIG. 22.

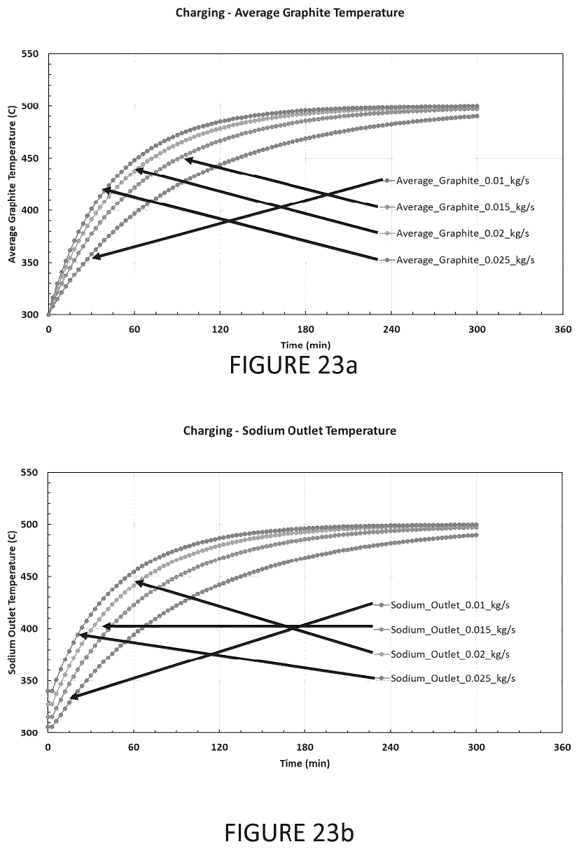

For the scenario during the charging phase, using an average graphite temperature of 300° C., a sodium inlet temperature of 500° C., varying sodium inlet flow from 0.01 to 0.025 kg/s and a run time of 300 minutes, the average charging graphite temperature and sodium outlet temperature is shown in FIG. 23.

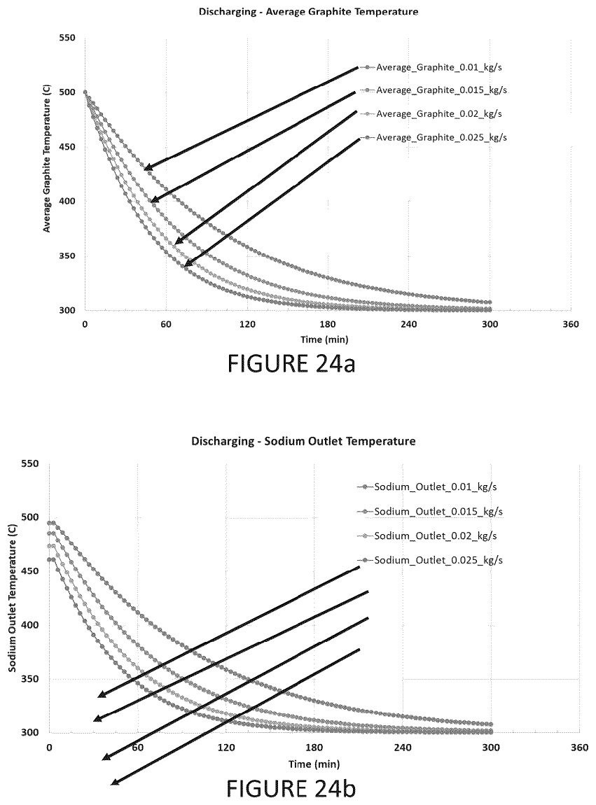

For the scenario during the discharging phase, using an average graphite temperature of 500° C., a sodium inlet temperature of 300° C., varying sodium inlet flow from 0.01 to 0.025 kg/s and a run time of 300 minutes, the average charging graphite temperature and sodium outlet temperature is shown in FIG. 24.

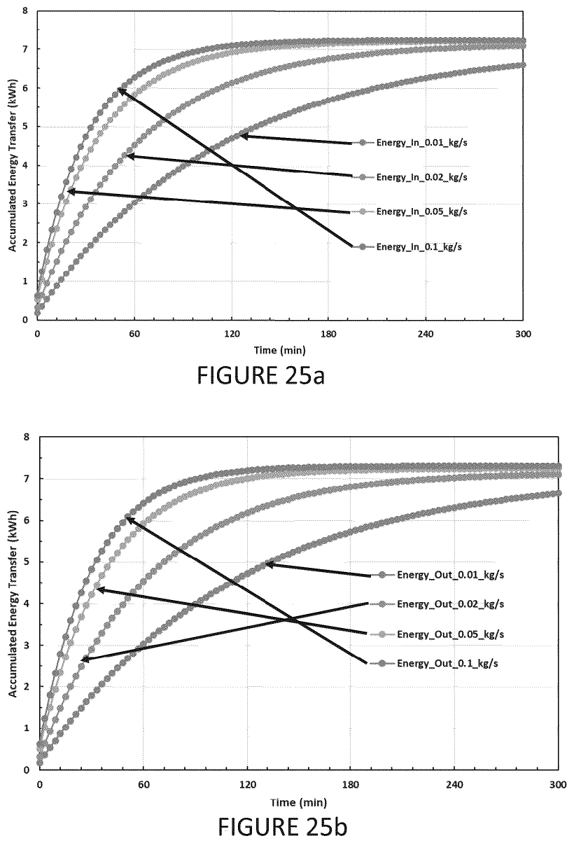

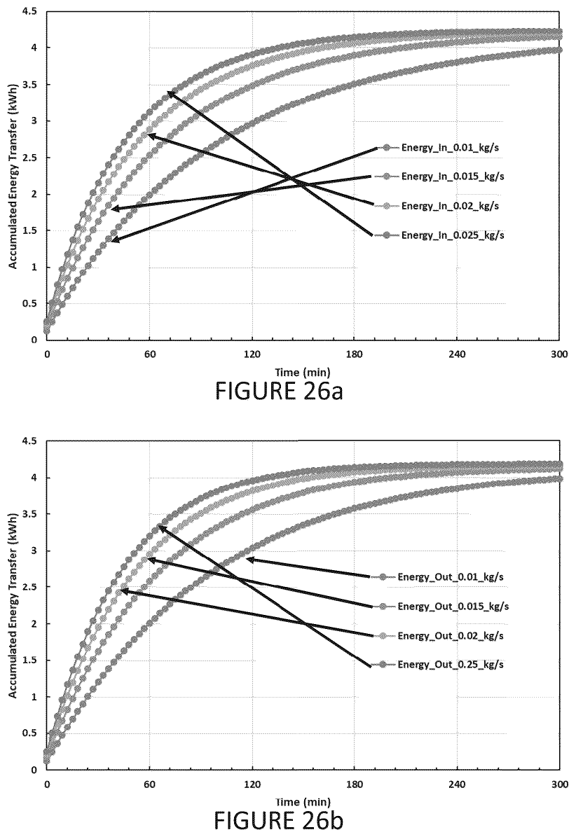

Based on the modelling, the energy transfer was also estimated. Energy transfer was calculated using the specific heat formula Q=mcΔT (equation 1) for sodium HTF per simulated time interval and converted to kWh and summed per time interval to provide accumulated energy transfer Q. The accumulated energy transfer for different charging and discharging temperatures is shown in FIGS. 25 and 26, respectively.

TABLE 6
Charging and discharging scenarios on energy input and output

| | Charging: 500-800° C. | | | Discharging: 800-500° C. | | | |
|---|---|---|---|---|---|---|---|
| Scenario: | | | Approx. | | | Approx. | |
| Flow | Charge | Sodium | Energy | Discharge | Sodium | Energy | Sodium mass |
| Rate | Time | ΔT | In | Time | ΔT | Out | displaced |
| (kg/s) | (min.) | (° C.) | (kWh) | (min.) | (° C.) | (kWh) | (300 min, kg) |
| 0.01 | >300 | 270 | 6.6 | >300 | 270 | 6.6 | 180 |
| 0.02 | 215 | 260 | 7.1 | 207 | 260 | 7.1 | 360 |
| 0.05 | 132 | 170 | 7.2 | 123 | 170 | 7.2 | 900 |
| 0.1 | 108 | 100 | 7.2 | 99 | 100 | 7.2 | 1,800 |
| | Charging: 300-500° C. | | | Discharging: 500-300° C. | | | |
| Scenario: | | | Approx. | | | Approx. | |
| Flow | Charge | Sodium | Energy | Discharge | Sodium | Energy | Sodium mass |
| Rate | Time | ΔT | In | Time | ΔT | Out | displaced |
| (kg/s) | (min.) | (° C.) | (kWh) | (min.) | (° C.) | (kWh) | (300 min, kg) |
| 0.01 | 300 | 185 | 4.0 | 276 | 185 | 4.0 | 180 |
| 0.015 | 213 | 185 | 4.2 | 192 | 185 | 4.2 | 270 |
| 0.02 | 165 | 175 | 4.2 | 150 | 175 | 4.2 | 360 |
| 0.025 | 141 | 160 | 4.2 | 129 | 160 | 4.2 | 450 |

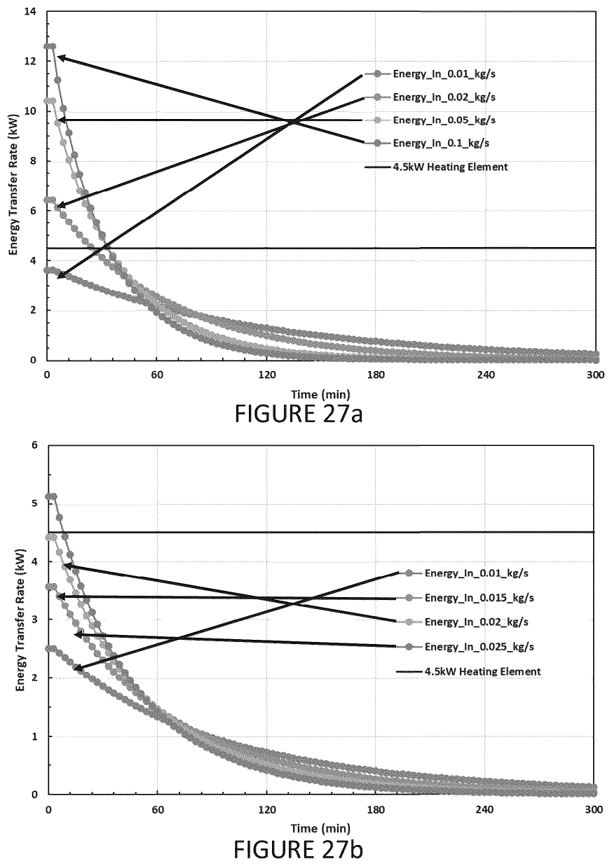

Similarly, the energy transfer rate was calculated using equation 1 and is shown in FIG. 27. However, only charging was calculated as sizing of heat input is relevant to maintain constant inlet sodium temperature. The discharging energy transfer rates are equivalent.

A summary of different scenarios showing the energy inputs and outputs is shown in Table 6, above.

Although the invention has been described with reference to specific examples it will be appreciated by those skilled in the art that the invention may be embodied in many other forms.

1-28. (canceled)

29. A method of operating a closed-loop power generation system with a heat energy transfer fluid (HTF) as the working fluid, the closed-loop power generation system comprising a thermal energy storage apparatus and a HTF turbine generator, the method comprising:
storing energy with the thermal energy storage apparatus, the thermal energy storage apparatus comprising:
a thermal energy storage panel housing defining a hollow interior chamber, the hollow interior chamber housing graphite solids material in an inert gas atmosphere therewithin, the thermal energy storage panel housing comprising a gas entry port configured to maintain an inert gas atmosphere within the hollow interior chamber by a positive flow of inert gas fed into the thermal energy storage panel housing; and
at least one conduit arranged to extend through the hollow interior chamber via inlet and outlet openings in the thermal energy storage panel housing, the at least one conduit being sealingly fitted to the thermal energy storage panel housing at the inlet and outlet openings, and an exterior surface of the at least one conduit being arranged in a close facing relationship with the graphite solids material located within the hollow interior chamber; and
contacting components of a flow of the heat energy transfer fluid (HTF) with the thermal energy storage apparatus via a heat exchanger to heat the components with the stored thermal energy; and
placing the flow of the heat energy transfer fluid (HTF) into fluid communication with the HTF turbine generator downstream of the heat exchanger;
wherein the at least one conduit is arranged for conveying the flow of the heat energy transfer fluid (HTF) therethrough such that in a first configuration, the flow transfers thermal energy to the graphite solids material, and in a second configuration, the graphite solids material transfers thermal energy to the flow;
wherein the contacting and the placing occur when the components require the stored thermal energy; and
wherein the heat energy transfer fluid (HTF) is a supercritical fluid.

30. The method according to claim 29, wherein the gas entry pump periodically pumps inert gas into the thermal energy storage panel housing.

31. The method according to claim 29, wherein the graphite solids material is solid blocks of graphite.

32. The method according to claim 31, wherein the solid blocks of graphite are graphite planks.

33. The method according to claim 29, wherein when the thermal energy storage apparatus is arranged with a single conduit, to operate in both the first configuration and the second configuration, the single conduit is adapted to convey different fluids sequentially therethrough.

34. The method according to claim 33, wherein the single conduit comprises a material suitable for conveying the flow of heat energy transfer fluid (HTF) when in the first configuration, and the single conduit comprises a material suitable for conveying the flow of a supercritical fluid when in the second configuration.

35. The method according to claim 33, wherein the single conduit comprises a material suitable for conveying the flow of heat energy transfer fluid (HTF) when in the first configuration, and the single conduit comprises a material suitable for conveying the flow of heat energy transfer fluid (HTF) when in the second configuration.

36. The method according to claim 29, wherein when the thermal energy storage apparatus is arranged with at least two conduits, to operate in the first configuration, the thermal energy storage apparatus is adapted to convey heat energy transfer fluid (HTF) in a first conduit, and to operate in the second configuration, the thermal energy storage apparatus is adapted to convey heat energy transfer fluid (HTF) in a second conduit, the second conduit separate from the first conduit.

37. The method according to claim 36, wherein the first conduit and the second conduit comprise a material with an operating temperature range of 550° C. to 1000° C.

38. The method according to claim 29, wherein the supercritical fluid is a carbon dioxide (sCO₂) working fluid in a Brayton Cycle turbine generator.

39. The method according to claim 29, wherein the heat energy transfer fluid (HTF) is used to operate the turbine generator to generate electricity.

40. The method according to claim 29, wherein the supercritical fluid is at least one compound selected from: carbon dioxide (CO₂), methane (CH₄), ethane (C₂H₆), propane (C₃H₈), ethylene (C₂H₄), propylene (C₃H₆), methanol (CH₃OH), ethanol (C₂H₅OH), acetone (C₃H₆O), and nitrous oxide (N₂O).
